(19) United States
(12) Patent Application Publication
(10) Pub. No.: US 2025/0331050 A1
(43) Pub. Date: Oct. 23, 2025

(54) Systems and Methods for Small Data Transmission in Half-Duplex Frequency Division Duplex Mode

(71) Applicant: Telefonaktiebolaget LM Ericsson (PUBL), Stockholm (SE)

(72) Inventors: Santhan THANGARASA, VÄLLINGBY (SE); Muhammad Ali KAZMI, RESTON, VA (US); Sandeep Narayanan KADAN VEEDU, JÄRFÄLLA (SE); Ming LI, STOCKHOLM (SE)

(21) Appl. No.: 18/727,451

(22) PCT Filed: Jan. 10, 2023
(86) PCT No.: PCT/EP2023/050485

§ 371 Date: Jul. 9, 2024

Related U.S. Application Data
(60) Provisional application No. 63/297,948, filed on Jan. 10, 2022.

(51) Int. Cl. H04W 76/20; H04W 24/08; H04W 68/02; H04W 74/0836

(52) U.S. Cl. CPC H04W 76/20; H04W 24/08; H04W 68/02; H04W 74/0836

(57) ABSTRACT

A method (1000) by a user equipment, UE, (412A-D) for adapting a small data transmission, SDT, includes determining (1002) that at least one proximity condition is fulfilled. The at least one proximity condition is associated with at least one resource for a SDT and at least one paging resource for receiving at least one paging related signal from a network node. The UE performs (1004) at least one task for adapting the SDT based on the at least one proximity condition being fulfilled.

### TECHNICAL FIELD

The present disclosure relates, in general, to wireless communications and, more particularly, systems and methods for Small Data Transmission (SDT) in Half-Duplex Frequency Division Duplex (HD-FDD) mode.

### BACKGROUND

3^{rd} Generation Partnership Project (3GPP) Release 17 (Rel-17) is expected to introduce the reduced capability (RedCap) user equipments (UEs) that can facilitate the expansion of the New Radio (NR) device ecosystem to cater to the use cases that are not yet best served by Release 15 (Rel-15)/Release 16 (Rel-16) NR specifications targeting Enhanced Mobile Broadband (eMBB)/Ultra Reliable Low Latency Communication (URLLC).

The use cases for NR RedCap include wearables (e.g. smart watches, wearable medical devices, Alternative Reality (AR)/Virtual Reality (VR) goggles, etc.), industrial wireless sensors, and video surveillance. Requirements for RedCap UE include the battery lifetime and device size. For example, wearable devices require at least several days and up to 1-2 week and industrial wireless sensors requires at least a few years for the battery life.

To achieve a small device size and/or longer battery lifetime, 3GPP has agreed to define RedCap UEs by considering the complexity reduction such as:
bandwidth reduction (e.g., the maximum bandwidth can be limited to 20 MHz for FR1 and 100 MHz for FR2):
reducing the maximum number of Multiple Input Multiple Output (MIMO) layers, e.g., having a single receive antenna:
relaxation of the maximum downlink (DL) modulation order (i.e., RedCap UE not required to support 256QAM or higher order modulation); and/or
allowing half-duplex (HD) operations in Frequency Division Duplex (FDD) bands may help reduce the complexity and material costs, for example by allowing duplex filter(s) to be replaced with a simple switch.

### Monitoring Paging in IDLE INACTIVE Mode

When a UE is in an IDLE/INACTIVE state, the UE monitors Physical Downlink Control Channel (PDCCH), which has transmission occasions that are configured by a gNodeB (gNB) every Discontinuous Reception (DRX) cycle. DRX cycle can be 320 ms, 640 ms, 1280 ms, and 2560 ms. 3GPP Rel-17 extends the DRX to enable a longer DRX period, which is called an extended DRX (eDRX). With eDRX, it is possible to extend DRX cycle up to 2.91 hours.

In NR, the paging occasions (POs) are associated with synchronization signal (SS) burst. There are two possible ways to multiplex Synchronization Signal Block (SSB) and PO:
SSB frequency division multiplexed with PO, and
SSB time division multiplexed with PO.

The summary of length and periodicity of PDCCH monitoring for different patterns is shown in Table 1.

TABLE 1
Summary of length and periodicity of PDCCH monitoring for different patterns

| | | Length of PDCCH | | |
|---|---|---|---|---|
| | PDCCH Monitoring | Monitoring Occasion | SFN in which PDCCH Monitoring Occasions are | Carrier |
| Patterns | Occasions Interval | per SSB | located | Frequency |
| Pattern 1 | Every 20 ms | 2 consecutive slots | a) SFN mod 2 = 0 for all SSBs OR | FR1, FR2 |
| | | | b) SFN mod 2 = 0 for some SSBs and SFN mod | |
| | | | 2 = 1 for others. | |
| Pattern 2/3 | SS burst set period | 1 slot | SFN in which SS burst set is transmitted. (Note: | FR2 |
| | (5, 10, 20, 40, 80, 160) ms | | SS burst set can be transmitted in any radio | |
| | | | frame of SS burst set period. | |

The paging frame (PF) and PO for paging are determined by the following formulae:
SFN for the PF is determined by:

$$( SFN + PF\_offset ) mod T = ( T div N ) * ( UE\_ID mod N )$$

Index (i_s), indicating the index of the PO is determined by:

$$i\_s = floor ( UE\_ID / N ) mod Ns$$

The PDCCH monitoring occasions for paging are determined according to pagingSearchSpace as specified in 3GPP TS 38.213 v17.0.0 and firstPDCCH-MonitoringOccasionOfPO and nrofPDCCH-MonitoringOccasionPerSSB-InPO if configured as specified in 3GPP TS 38.331. When SearchSpaceId=0 is configured for pagingSearchSpace, the PDCCH monitoring occasions for paging are same as for RMSI as defined in clause 13 in TS 38.213 v17.0.0.

When SearchSpaceld=0 is configured for pagingSearchSpace, Ns is either 1 or 2. For Ns=1, there is only one PO which starts from the first PDCCH monitoring occasion for paging in the PF. For Ns=2. PO is either in the first half frame (i_s=0) or the second half frame (i_s=1) of the PF.

When SearchSpaceld other than 0) is configured for pagingSearchSpace, the UE monitors the (i_s+1)^{th} PO. A PO is a set of ‘S*X’ consecutive PDCCH monitoring occasions where ‘S’ is the number of actual transmitted SSBs determined according to ssb-PositionsInBurst in SIBI and X is the nrofPDCCH-MonitoringOccasionPerSSB-InPO if configured or is equal to 1 otherwise. The [x*S+K]^{th} PDCCH monitoring occasion for paging in the PO corresponds to the K^{th} transmitted SSB, where x=0.1 . . . . X−1, K=1,2 . . . , S. The PDCCH monitoring occasions for paging which do not overlap with UL symbols (determined according to tdd-UL-DL-ConfigurationCommon) are sequentially numbered from zero starting from the first PDCCH monitoring occasion for paging in the PF. When firstPDC CH-MonitoringOccasionOfPO is present, the starting PDCCH monitoring occasion number of (i_s+1)^{th} PO is the (i_s+1)^{th} value of the firstPDCCH-MonitoringOccasionOfPO parameter: otherwise, it is equal to i_s*S*X. If X>1, when the UE detects a PDCCH transmission addressed to P-RNTI within its PO, the UE is not required to monitor the subsequent PDCCH monitoring occasions for this PO.

### Half-Duplex

3GPP NR defines three duplex schemes: Time Division Duplex (TDD), Full-duplex Frequency Division Duplex (FD-FDD) (or simply FDD) and Half-Duplex Frequency Division Duplex (HD-FDD). In TDD operation, the UE and base station (e.g. gNodeB (gNB)) use a single carrier frequency and switch between uplink (UL) and downlink (DL) transmission in time domain. On the other hand, FDD uses two paired carrier frequencies, wherein one carrier frequency is used for UL and the other carrier frequency is used for DL transmission. The difference between full-duplex and half-duplex is that a FD-FDD UE can transmit and receive data simultaneously, while in HD-FDD, the UE switches between UL transmission and DL transmission in time domain in the same fashion as TDD, but the UE uses different frequencies for UL and DL transmission. The base station (e.g. gNB) behaves differently for HD-FDD and TDD. The base station (e.g., gNB) behaves the same for both HD-FDD UE and FD-FDD UE (i.e., the base station operates in FD-FDD).

For a base station operating in FDD bands, since the base station handles both HD-FDD UEs and FD-FDD UEs, the base station schedules or transmits reference signals (e.g., SSB, Channel State Information-Reference Signal (CSI-RS), Tracking Reference Signal (TRS), etc.), targeting both HD-FDD UEs and FD-FDD UEs. The UE should receive these channel signals for one or more procedures such as, for example, cell detection, measurements, radio link monitoring (RLM), link recovery, time/frequency tracking. Automatic Gain Control (AGC), etc.), regardless of regardless of full-duplex or half-duplex.

For a RedCap device, the support of FD-FDD is optional, i.e., it is not required to receive in the DL frequency while transmitting in the UL frequency, and vice versa. HD-FDD obviates the need for duplex filters. Instead, a switch can be used to select the transmitter or receive to connect to the antenna. As a switch is less expensive than multiple duplexers, cost savings are achieved.

A FD-FDD UE requires two oscillators. One oscillator is used for UL frequency, and another oscillator is used for DL frequency. The RedCap UE of HD-FDD type-A, also operates using two oscillators. This means that when the UE needs to receive DL signals, the UE tunes the oscillator frequency to DL frequency and when the UE needs to transmit UL signals, the UE tunes the oscillator frequency to UL frequency. A HD-FDD UE with a single oscillator requires a switching period or transmission period for switching from DL frequency to UL frequency, T_{DL-to-UL}, and from UL frequency to DL frequency. T_{UL-to-DL}. One example of a transition time is T_{DL-to-UL}=T_{UL-to-DL}=1 ms. The HD-FDD capable UE may indicate its capability to the network such as, for example, via RRC signaling and/or NAS signaling. The HD-FDD capability may be band dependent. For example, the same UE may support HD-FDD operation for one band while FDD operation for another band.

### Small Data Transmission (SDT)

In NR, in RRC_INACTIVE state, a UE with infrequent periodic and/or aperiodic data can transmit a small amount of data, which is called as small data transmission (SDT). SDT is, therefore, a procedure to transmit UL data by the UE in RRC_INACTIVE state. SDT is performed with either random access (using Random Access Channel (RACH)-based SDT) or configured grant (CG) (using Configured Grant (CG) based SDT). If the UE uses 4-step RA type for SDT procedure, then the UE transmits the UL data in the Msg3. If the UE uses 2-step RA type for SDT procedure, then the UE transmits UL data in the MsgA.

CG Physical Uplink Shared Channel (CG PUSCH) resources are the Physical Uplink Shared Channel (PUSCH) resources configured in advance for the UE. When there is UL data available in UE's buffer, the UE can start UL transmission using the pre-configured PUSCH resources without waiting for an UL grant from the base station (e.g. gNB), reducing the latency. From Rel-15, NR supports CG type 1 PUSCH transmission and CG type 2 PUSCH transmission in RRC_CONNECTED. For both types, the PUSCH resources (time and frequency allocation, periodicity, etc.) are preconfigured via dedicated Radio Resource Control (RRC) signaling. The CG type 1 PUSCH transmission is activated/deactivated by RRC signaling, while the CG type 2 PUSCH transmission is activated/deactivated by an UL grant using DL control information (DCI) signaling. The Rel-17 CG-based SDT in RRC_INACTIVE state is based on the CG type 1 PUSCH transmission. An association between CG resources and SSBs is configured for CG-based SDT.

The UE is allocated with or pre-configured with resources during RRC connected state and may also be assigned a timing advance (TA) value by the serving cell. The UE may further be configured with a validity timer along with the TA value to determine validity of the configured TA time. Upon expiry of the validity timer, the configured TA becomes invalid and the CG-SDT resources also become invalid. An example of the validity timer is a time alignment timer (TAT).

Upon arrival of the data in the UE buffer, the UE may decide whether to use SDT mechanism or legacy mechanism (e.g., by sending RRCResumeRequest) to transmit the data based on comparison between the Reference Signal Received Power (RSRP) of configured Reference Signal (RS) and RSRP threshold (e.g. RSRP-threshold-STD). For example, the SDT mechanism is selected if the RSRP is above RSRP-threshold-STD; otherwise, a legacy mechanism is used. The UE selects the CG-SDT resource for transmission based on comparison between the RSRP of configured RS and RSRP threshold. For example, CG-SDT resources associated with or corresponding a RS (e.g., SSB) whose RSRP is above RSRP threshold (e.g., RSRP-thresholdCG) are selected by the UE for data transmission.

There currently exist certain challenge(s), however. For example, the 3GPP RANI has discussed the overlapping of DL and UL transmissions of a HD-FDD UE and reached an agreement to revise RANI #106bis-e as follows:
For Case 3, semi-statically configured DL reception vs. semi-statically configured UL transmission
   A HD-FDD UE does not expect to receive both dedicated higher layer parameters configuring transmission from the UE in the set of symbols of the slot and dedicated higher layer parameters configuring reception in the set of symbols of the slot
   A HD-FDD UE does not expect to receive both dedicated higher layer parameters configuring transmission from the UE in the set of symbols of the slot and cell specific higher layer parameters configuring reception in the set of symbols of the slot
      Cell-specifically configured DL reception refers to PDCCH in Type-0/0A/1/2 CSS set

Since a network configuration is not standardized and the UE in RRC INACTIVE state may receive Core Network-originated paging, which is transparent to the network, situations could arise where the paging reception and CG-SDT transmission overlap partly or fully in time resources. For example, even if the UE operates in HD-FDD mode, the network (e.g., a gNB) still operates in FD-FDD mode and may have to schedule other UEs that are not operating in HD-FDD mode. Therefore, it may not always be possible for the network to always avoid such DL/UL conflict in the UE. Since the HD-FDD UE cannot receive and transmit simultaneously, the UE behaviour in this situation is currently unknown and/or undefined.

### SUMMARY

Certain aspects of the disclosure and their embodiments may provide solutions to these or other challenges. For example, methods and systems are provided to define the behavior of a UE operating in HD-FDD mode that is preconfigured with CG resources for SDT transmissions in low activity states that at least partially overlap in time with paging receptions and/or when there is no sufficient switching gap between UL transmissions and DL receptions.

According to embodiments, a method by a UE for adapting a SDT includes determining that at least one proximity condition is fulfilled. The at least one proximity condition is associated with at least one resource for a SDT and at least one paging resource for receiving at least one paging related signal from a network node. The UE performs at least one task for adapting the SDT based on the at least one proximity condition being fulfilled.

According to certain embodiments, a UE for adapting a SDT includes processing circuitry configured to determine that at least one proximity condition is fulfilled. The at least one proximity condition being associated with at least one resource for a SDT and at least one paging resource for receiving at least one paging related signal from a network node. The processing circuitry is configured to perform at least one task for adapting the SDT based on the at least one proximity condition being fulfilled.

Embodiments may provide one or more of the following technical advantage(s). For example, embodiments may provide a technical advantage of defining UE behavior for handling transmission of CG-SDT in UL and paging reception in DL in half-duplex operation. This enables the base station to improve or optimize the usage of its resources, and overhead of signaling can be saved. As another example, embodiments may provide a technical advantage of not wasting scheduling grants.

Certain embodiments may have other advantages than those suggested. Other advantages may be readily apparent to one having skill in the art.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates an example method in a wireless device for adapting SDT transmission(s) based on paging information, according to certain embodiments;

FIG. 2 illustrates an example with SR1 and PR1 partially overlapping in time, according to certain embodiments:

FIG. 3 illustrates an example with SR1 and PR1 being sufficiently close in time, according to certain embodiments:

FIG. 4 illustrates an example communication system, according to certain embodiments:

FIG. 5 illustrates an example UE, according to certain embodiments;

FIG. 6 illustrates an example network node, according to certain embodiments:

FIG. 7 illustrates a block diagram of a host, according to certain embodiments:

FIG. 8 illustrates a virtualization environment in which functions implemented by some embodiments may be virtualized, according to certain embodiments:

FIG. 9 illustrates a host communicating via a network node with a UE over a partially wireless connection, according to certain embodiments; and

FIG. 10 illustrates an example method by a UE for adapting a SDT, according to certain embodiments.

### DETAILED DESCRIPTION

Some embodiments contemplated herein will now be described more fully with reference to the accompanying drawings. Embodiments are provided by way of example to convey the scope of the subject matter to those skilled in the art. Additional information may also be found in the document(s) provided in the Appendix.

In some embodiments, general terms of ‘node’ or ‘radio node’ are used to indicate a network node or a UE capable of transmitting radio signals or receiving radio signals or both.

In embodiments, the general terms ‘network node’ and ‘radio network node’ are used to refer to any type of radio network node or any network node, which communicates with a UE and/or with another network node. Examples of network nodes are NodeB, base station (BS), multi-standard radio (MSR) radio node such as MSR BS, eNodeB (eNB), gNodeB (gNB). Master eNB (MeNB). Secondary eNB (SeNB), integrated access backhaul (IAB) node, network controller, radio network controller (RNC), base station controller (BSC), relay, donor node controlling relay, base transceiver station (BTS). Central Unit (e.g, in a gNB). Distributed Unit (e.g, in a gNB). Baseband Unit. Centralized Baseband. C-RAN, access point (AP), transmission points, transmission nodes. Remote Radio Unit (RRU). Remote Radio Head (RRH), nodes in distributed antenna system (DAS), core network node (e.g. Mobile Switching Center (MSC). Mobility Management Entity (MME), etc.). Operations & Maintenance (O&M). Operations Support System (OSS). Self Organizing Network (SON), positioning node (e.g. E-SMLC), etc.

In embodiments, the non-limiting term ‘user equipment’ or UE or wireless device is used and refers to any type of wireless device communicating with a network node and/or with another UE in a cellular or mobile communication system. Examples of UE are target device, device to device (D2D) UE, vehicular to vehicular (V2V), machine type UE. MTC UE or UE capable of machine to machine (M2M) communication. Personal Digital Assistant (PDA). Tablet, mobile terminals, smart phone, laptop embedded equipment (LEE), laptop mounted equipment (LME). Unified Serial Bus (USB) dongles, etc.

The term radio access technology (RAT), may refer to any RAT such as, for example. Universal Terrestrial Radio Access Network (UTRA). Evolved Universal Terrestrial Radio Access Network (E-UTRA), narrow band internet of things (NB-IoT). WiFi. Bluetooth, next generation RAT, NR, 4G. 5G, etc. Any of the equipment denoted by the terms node, network node or radio network node may be capable of supporting a single or multiple RATs.

In embodiments, solutions are described using generic terms of DL reception or DL signal reception and UL transmission or UL signal transmission. DL reception can include reception of one or more DL signals. Examples of DL signals are physical DL channels and DL physical signals. The physical channel (DL or UL) may carry higher layer information such as, for example, control, data, etc. Examples of DL physical channels are Physical Downlink Shared Channel (PDSCH). Physical Downlink Control Channel (PDCCH), Physical Broadcast Channel (PBCH). CORSET, etc. Examples of physical signals (DL or UL) are reference signals (may also be called as pilot signals, training sequence, etc.). Examples of DL Reference Signal (RS) are Primary Synchronization Signal (PSS). Secondary Synchronization Signal (SSS). Synchronization Signal Block (SSB). Channel State Information-Reference Signal (CSI-RS). Positioning Reference Signal (PRS). Tracking Reference Signal (TRS). Demodulation Reference Signal (DMRS), reference signals (e.g. PSS. SSS. DMRS, etc.) within SSB, etc. Similarly. UL transmission can include physical UL channels or signals. Examples of UL physical channels are Physical Uplink Shared Channel (PUSCH). Physical Uplink Control Channel (PUCCH). Scheduling Request (SR), etc. Examples of UL RS are DMRS. Sounding Reference Signal (SRS), etc. When DL reception or UL transmission is described as being dynamically scheduled or semi-statically configured, it can therefore cover all the mentioned physical channels and signals.

The term “time resource”, as used herein, may correspond to any type of physical resource or radio resource expressed in terms of length of time. Examples of time resources are: symbol, sub-slot, mini-slot, time slot, subframe, radio frame, transmission time interval (TTI), interleaving time, frame. System Frame Number (SFN) cycle, hyper-SFN (H-SFN) cycle, etc.

The techniques and methods disclosed herein are intended for NR HD-FDD capable UEs. An example of NR HD-FDD capable UE is NR HD-FDD Type-A UE, where two separate local oscillators for DL and UL carrier frequencies are assumed compared to HD-FDD Type-B UE where only a single local oscillator is assumed. They provide UE behavior in handling DL/UL collision for HD-FDD UEs. However, it is recognized that the techniques and methods disclosed herein are not necessarily restricted to only HD-FDD UEs and may be applied to any type of UE.

The terms ‘SDT’, ‘transmissions using CG-configured PUSCH resources in Radio Resource Control (RRC) inactive and/or RRC idle state’, and ‘transmissions using preconfigured uplink resources (PUR)’ are used interchangeably. In this context, all terms refer to transmissions using preconfigured UL resources in one or more UL channels (e.g., PUSCH, PUCCH, PRACH). In some examples, the terms ‘PUR’ and ‘ ’transmission using CG resources are used interchangeably.

Herein, the term ‘adapting reception of a signal’ may imply the UE does not receive the signal. The term ‘adapting transmission of a signal’ may imply the UE does not transmit the signal. The term ‘adapting signal reception’ may also interchangeably be described using terms such as ‘cancelling’, ‘discarding’, ‘abandoning’, ‘stopping’, ‘reassigning’, ‘suspending’ or ‘postponing reception of signal’, ‘not receiving the signal’, etc. Similarly, the term ‘adapting signal transmission’ may also interchangeably be described using terms such as ‘cancelling’, ‘discarding’, ‘abandoning’, ‘stopping’, ‘suspending’, ‘reassigning’, or ‘postponing transmission of the signal’, ‘not transmitting the signal’, etc.

According to particular embodiments, examples of rules that may be applied by the UE include:
In one example, if at least one SPP condition is met, then the UE discards the data transmission SR1 and/or postpones the data transmission in a second SDT resource (SR2), which occurs after SR1 in time.
In another example, if at least one SPP condition is met, then the UE selects a SDT method for data transmission which avoids interruption to the paging reception e.g. during PR1.
In another example, if at least one SPP condition is met, then the UE does not monitor paging in a first paging occasion (PO1), where at least one SPP condition is met for PO1 and SR1.
In another example, if none of the SPP conditions is met, then the UE decides to transmit the data using the SDT resource (e.g, in SR1).
In another example, if none of the SPP conditions is met then the UE decides to receive or monitor the paging during the paging resource e.g, in PR1.

Since a HD-FDD UE cannot receive and transmit simultaneously, situations could arise where the paging reception and CG-SDT transmission overlap partly or fully in time. Since there might be UEs of different duplex modes in the same cell, it is not always possible to avoid such collision by the gNB and specification should be clear on what operation shall be prioritized when collision occurs. Paging reception is more important than SDT data and UE shall, therefore, not miss the paging reception even if paging reception is colliding with CG-SDT transmission in time. Accordingly, methods and systems are provided to define the behavior of a UE operating in HD-FDD mode that is preconfigured with CG resources for SDT transmissions in low activity states that at least partially overlap in time with paging receptions and/or when there is no sufficient switching gap between UL transmissions and DL receptions. Specifically, it is proposed that, when there is an overlap between paging reception and CG-SDT transmission occasion in time domain for a HD-FDD UE, the UE shall not miss the paging reception and the UE is allowed to drop the CG-SDT transmission.

Certain embodiments described herein apply to a scenario that includes a UE operating in HD-FDD mode and being served by a cell (cell1) managed by first network node (NW1). The UE is further configured/preconfigured in cell1 with CG resources for SDT transmissions. The configured resources for SDT transmissions can be used by the UE when the UE operates in or is configured in a low activity state such as, for example, a RRC INACTIVE state, a RRC idle state, etc. The configured SDT transmission occasions may occur with certain periodicity, such as, for example, every 320 ms, 640 ms, etc. The UE is also configured to receive paging messages in at least one paging occasion. The paging occasions may follow a certain periodicity, which may be interchangeably called a paging cycle or paging periodicity. For example, the paging occasions may be periodically transmitted every DRX cycle or every Nth DRX cycle, where N=1, 2, 4, etc. Certain embodiments described herein apply in one or more of the following scenarios:
when the SDT transmission resource and resource used for paging reception (e.g., PO) overlap at least partly in time, and/or.
when the SDT transmission resource and resource used for paging reception (e.g. PO) are “back-to-back” but non-overlapping such as when the paging occasions are close enough with respect to each other in time to cause interruption to at least one of SDT transmission and paging reception. The interruption may occur due to switching between the DL and UL frequencies, processing in the UE etc.
   The UE can be configured with either normal DRX or extended DRX cycles.

It is noted that a HD-FDD UE is not expected to transmit in the UL earlier than N_{RX-TX} T_{c} after the end of the last received DL symbol in the same cell. Also, a HD-FDD UE is not expected to receive in the DL earlier than N_{TX-RX} T_{c} after the end of the last transmitted UL symbol in the same cell. The transition times N_{RX-TX} T_{c} and N_{TX-RX} T_{c}, where T_{c} is the NR basic time unit as specified in 3GPP TS 38.211, are the same as for a legacy NR UE not capable of full-duplex communication.

According to a particular embodiment, the UE adapts at least transmission of CG-SDT based on a relation between CG-SDT transmission occasion periodicity (H1) and paging reception periodicity (H2).

According to another particular embodiment, a UE served by a first cell (cell1), determines, upon triggering of data transmission using a first SDT resource (SR1), whether one or more SDT-paging reception proximity (SPP) conditions are going to be met if the UE transmits data using SR1. The UE performs one or more operational tasks according to one or more rules based on whether the one of more SPP conditions are going to be met.

In a particular embodiment, the SPP condition defines a relation, association or mapping in time between configured SDT resource (SR) and configured paging reception resource (PR) in time. The timing relation may indicate whether the SR (e.g. SR1) and the PR (e.g. PR1) overlap in time or they are non-overlapping but close in time with regard to each other within certain margin. The scenario where the SR (e.g. SR1) and the PR (e.g. PR1) overlap in time may also be referred to as SR (e.g. SR1) colliding with the PR (e.g. PR1) in time or the PR (e.g. PR1) colliding with SR (e.g. SR1) in time. The overlap or collision between the SR (e.g. SR1) and the PR (e.g. PR1) may be fully or partially in time. The scenario where the SR (e.g. SR1) and the PR (e.g. PR1) do not overlap in time may also be referred to as SR (e.g. SR1) not colliding with the PR (e.g. PR1) in time or the PR (e.g. PR1) not colliding with SR (e.g. SR1) in time.

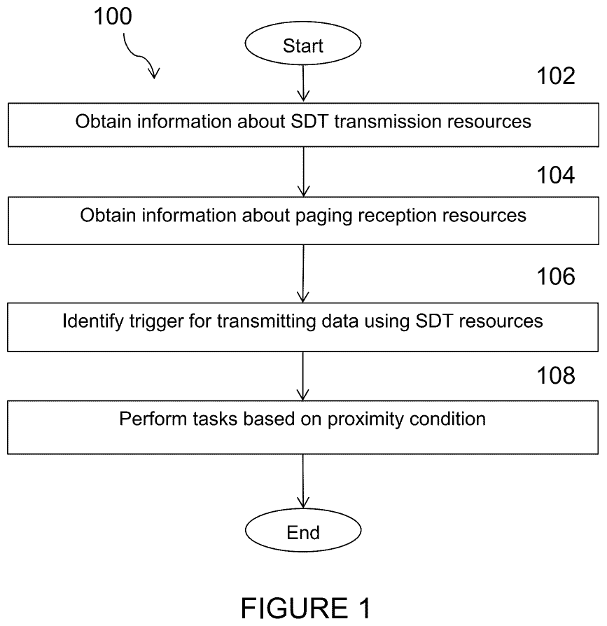

FIG. 1 illustrates an example method 100 in a wireless device for adapting SDT transmission(s) based on paging information, according to certain embodiments. In a step 102, the wireless device, which may include a UE, obtains information about SDT transmission resources.

In a particular embodiment, for example, the wireless device obtains information about preconfigured resources for SDTs (e.g., CG-SDT configurations, RACH-SDT configurations, etc.). This information includes but is not limited to any one or more of the following:
pre-configured radio resources for transmission (e.g., PUSCH allocation, RACH allocation, etc.),
frequency of pre-configured radio resources for transmission (e.g., whether the assigned CG-SDT resources are, for example, periodic or aperiodic and a periodicity where the resources are periodic, and/or
TA value associated with the pre-configured resources (e.g., CG-SDT configuration).

The CG-SDT resources can be of different types such as, for example, dedicated, contention-free shared, or contention-based shared CG-SDT resource. The obtained information about CG-SDT configuration may comprise, for example, the CG-SDT transmission periodicity (e.g. SDT transmission resource taking place every Nth ms and for a duration of M ms), SDT start position, and TA information with respect to the target cell. The CG-SDT transmission resource may comprise one or more time-frequency resources (e.g. resource blocks, subcarriers, etc.). A UE can be provided with multiple CG-SDT configurations and each CG-SDT configuration can be associated with one or more SSBs. The aforementioned information about CG-SDT configuration may be common for the multiple CG-SDT configurations or they may be specific to a CG-SDT configuration.

In various particular embodiments, the UE may obtain information about pre-configured resources for SDT (e.g. CG-SDT configuration) using one or more of the following mechanism:
by receiving a message from the network node associated with cell1, and
based on pre-defined information such as, for example, a pre-defined value of TAT timer, a pre-defined or default periodicity of pre-configured resources, etc.

At step 104, the wireless device obtains information about paging reception resources. In a particular embodiment, for example, the UE obtains a paging configuration indicating the paging reception periodicity.

The network (e.g., a network node such as a gNB) typically configures several paging occasions per DRX cycle (e.g. 128 POs within a DRX cycle of 1.28 seconds). The paging configuration may include an amount of paging occasions (POs) and/or the positions in time. The paging configuration is broadcast over the air in system information (part of SIBI contents). When a UE registers in the NW, it gets assigned a UE identity called 5G-S-TMSI. This identity is used by the UE and NW in a formula specified by 3GPP to derive in which of the configured occasions the UE will listen for a potential paging message. It shall be noted that several UEs could be listening for a potential paging message at the very same PO. There can also be multiple PDCCH monitoring occasions per PO corresponding to multiple transmitted SSB indexes.

In case a UE detects a paging DCI (i.e., DCI 1_0 with P-RNTI-scrambled CRC), the UE looks in the payload of the PDSCH to see whether the UE's identity is present and, thus, if the paging message was intended for that UE. The payload of the PDSCH might carry up to 32 identities. Thus, up to 32 UEs may be paged during the very same PO. Even though a UE's 5G-S-TMSI ID is used in the formulas for deriving the PO, the identity that the UE looks for inside the PDSCH may be of another type. Thus, the UE in an RRC_INACTIVE state has to look both for 5G-S-TMSI and the RAN-assigned I-RNTI identity. In other words, a UE in RRC INACTIVE state may be either paged by the CN or the RAN and, thus, needs to look for both assigned identities. Note that “short messages” carrying information on system information modification and/or ETWS/CMAS notification are included in the paging DCI (and not on paging RRC message on the PDSCH).

At step 106, the wireless device is triggered to transmit and/or identifies a trigger for transmitting data using SDT resources. The triggering of the data transmission can be based on one or more conditions such as, for example, upon arrival of data in the UE buffer, retransmission of previously transmitted data, request received from a network node, expiry of timer (e.g. transmission of periodic signal (e.g. SRS) or measurement (e.g. buffer status report)), etc. The term data may refer to any of: user data, control information, signalling message, etc. The UE further determines a SDT resource, a first SDT resource (SR1), which the UE may use for the data transmission in response to the trigger. In one example, SR1 may be the first available or configured SDT resource occurring in time after the triggering of the data transmission. In another example, SR1 may be the SDT resource occurring in time after the triggering of the data transmission and which the UE can conveniently use for data transmission, taking into account the UE processing, etc.

At step 108, the wireless device performs tasks based on at least one proximity condition. Specifically, before transmitting the data using SR1, the UE further verifies or determines whether the UE meets one or more proximity conditions. For example, the UE may determine whether the UE meets at least one SDT resource-paging reception resource proximity (SPP) condition. According to certain embodiments, the UE performs one or more radio operational tasks when the UE meets the at least one SPP condition.

The SPP defines relation, association or mapping in time between configured SDT resource (SR) and configured paging reception resource (PR) in time. At least one SPP is met provided that the SR and the PR are related or associated with each in time. Otherwise, no SPP condition is met by the UE. In one example, SR may refer to SR1 (which is defined in step 108). In one example, PR may refer to a first PR (PR1). In a particular embodiment, for example, PR1 may be a first PO (PO1). PR1 or PO1 may be related to SR1 in time.

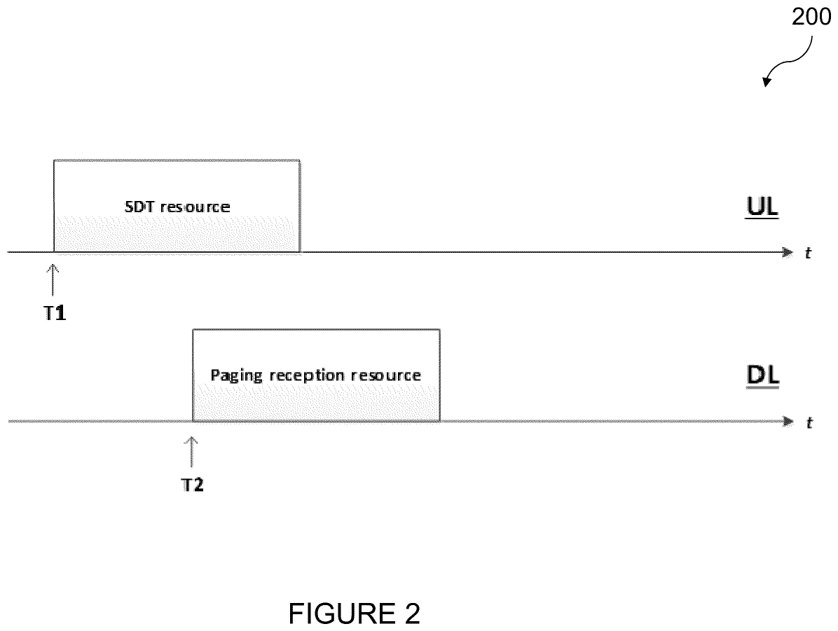

SPP is further described below using several examples of rules. In one example of the rule, the SPP is met if SR1 and PR1 at least partially overlap in time with respect to each other. FIG. 2 illustrates such an example 200 with SR1 and PR1 partially overlapping in time, according to certain embodiments.

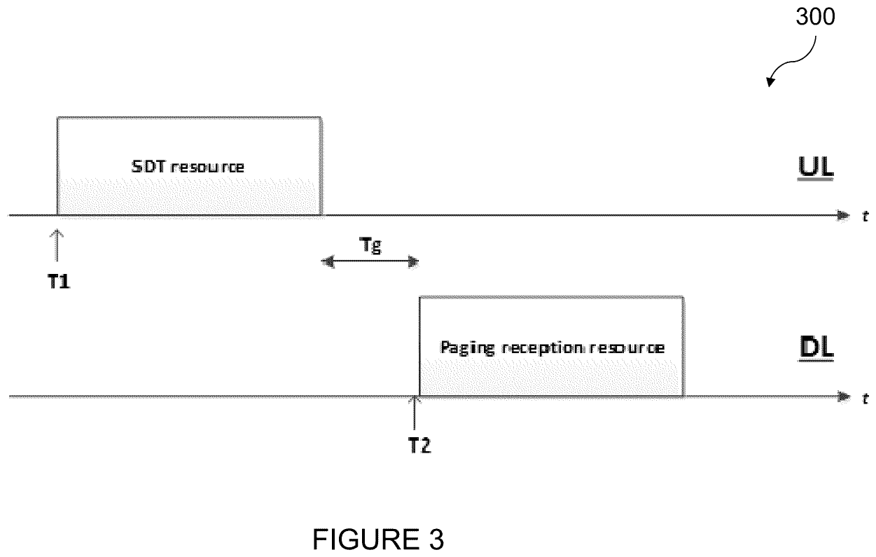

In another example of the rule, the SPP is met if SR1 and PR1 are close in time with respect to each other even though SRS1 and PR1 may not overlap in time. FIG. 3 illustrates an example 300 with SR1 and PR1 being sufficiently close in time, according to certain embodiments. As illustrated, the closeness in time is determined based on a relation between the time gap (Tg) between SR1 and PR1 and a threshold (H1). Tg may be defined as the time period between the end of SR1 in time and the start of PR1 in time. In another example, Tg may be defined as the time period between the end of PR1 in time and the start of SR1 in time.

In a particular embodiment, for example, the SPP is met if Tg<H1. Otherwise, the SPP is not met.

In still another example of the rule, the SPP is met when the SR1 and PR1 at least partially overlap in time with respect to each other and at least one condition related to the configured SDT resource transmission periodicity (Tsr) is met. In particular embodiments, the condition related to the Tsr may depend on a relation or mapping between Tsr and a threshold. Examples of relations are comparison, greater than, less than, average, maximum, sum, product, ceiling, floor, a combination of two or more of these or other functions, etc. In one example, the condition related to the Tsr is met when Trs<H21. In another example, the condition related to the Tsr is met when Trs>H22. It may be recognized that H21 and H22 are thresholds that can be pre-defined or configured by the network node.

In another example of the rule, the SPP is met when the SR1 and PR1 at least partially overlap in time with respect to each other and at least one condition related to the configured paging reception resource periodicity (Tpr) is met. In particular embodiments, the condition related to the Tpr depends on a relation or mapping between Tpr and a threshold. Examples of relations are comparison, greater than, less than, average, maximum, sum, product, ceiling, floor, a combination of two or more of these or other functions, etc. In one example, the condition related to the Tpr is met when Tpr<H31. In another example, the condition related to the Tpr is met when Tpr>H32. It may be recognized that H31 and H32 are thresholds that can be pre-defined or configured by the network node.

In another example of the rule, the SPP is met when the SR1 and PR1 at least partially overlap in time with respect to each other and at least one condition related to a relation between Tsr and Tpr is met. In particular embodiments, the condition related to the relation between Tsr and Tpr depends on a relation or mapping between Tsr, Tpr, and one or more thresholds and parameters (e.g. scaling factor).

In one example, the condition related to the relation between Tsr and Tpr is met when Tsr<f1 (K1, Tpr. H41). In one specific example, the condition is met when Tsr< (K1*Tpr+H41). In another example, the condition related to the relation between Tsr and Tpr is met when Tsr>f2 (K2. Tpr. H42). In one specific example, the condition is met when Tsr> (K2*Tpr+H42).

In another example, the condition related to the relation between Tsr and Tpr is met when Tpr<f3 (K3. Tsr. H43). In one specific example, the condition is met when Tpr< (K3*Tsr+H43).

In another example, the condition related to the relation between Tsr and Tpr is met when Tpr>f4K4, Tsr. H44). In one specific example, the condition is met when Tpr> (K4*Tsr+H44).

In the above examples, K1, K2, K3 and K4 are scaling factors, which may be pre-defined or configured by the network node. They may have the same or different values. In one example, K1=K2-K3=K4=1. In another example, K1>1: K2>1: K3>1; K4>1.

In the above examples, H41, H42, H43 and H44 are thresholds, which may be pre-defined or configured by the network node. They may have the same or different values. In one example, H41-H42-H43=H44=0.

In another example of the rule, the SPP is met when the SR1 and PR1 at least partially overlap in time with respect to each other, and at least any two of the following conditions are met:
at least one condition related to Tsr as described in example of rule #3,
at least one condition related to Tpr as described in example of rule #4 and
at least one condition related to relation between Tsr and Tpr as described in example of rule #5.

In another example of the rule, the SPP is met when SR1 and PR1 are close in time with respect to each other (as described in rule 2) and at least one condition related to Tsr is met. Examples of the conditions related to Tsr are the same as described above.

In another example of the rule, the SPP is met when SR1 and PR1 are close in time with respect to each other (as described in rule 2) and at least one condition related to Tpr is met. Examples of the conditions related to Tpr are the same as described above.

In another example of the rule, the SPP is met when SR1 and PR1 are close in time with respect to each other (as described in rule 2) and at least one condition related to the relation between Tsr and Tpr is met. Examples of the conditions related to the relation between Tsr and Tpr are the same as described above.

In another example of the rule, the SPP is met when SR1 and PR1 are close in time with respect to each other (as described in rule 2), and at least any two of the following conditions are met:
at least one condition related to Tsr as described in example of rule #3,
at least one condition related to Tpr as described in example of rule #4 and
at least one condition related to relation between Tsr and Tpr as described in example of rule #5.

According to certain embodiments, if the UE does not meet even one SPP condition, then the UE performs a first set of operational tasks (OT1), which includes at least one task. Examples of OT1 include any one or more of:
1. In one example of OT1, the UE decides to transmit the data using SR1. The UE may further transmit the data provided that one or more criteria required for SDT transmission are met. Examples of the criteria are: the UE available transmission power is above certain threshold, the UE transmit timing error for transmitting the data is below or will remain below certain threshold, TA used for transmitting the data is valid (e.g., a magnitude of the difference between RSRP1 and RSRP2 is below certain threshold). RSRP1 is estimated by the UE around the time the UE is configured with a TA command. RSRP2 is estimated by the UE around the time when the UE decides to transmit the data.
2. In another example of OT1, the UE decides to receive or monitor the paging during PR1. In one particular example, the UE may further receive or monitor the paging during PR1 without checking any other condition. In another particular example, the UE may further receive or monitor the paging provided that one or more criteria required for paging reception are met. Examples of the criteria are: the UE battery power is above certain threshold, the UE is synchronized with regard to cell1 (e.g., synchronized to DL timing of cell1 by monitoring a reference cell (e.g., SSB) of cell1), etc.

According to certain embodiments, if the UE meets at least one SPP condition, then the UE performs a second set of operational tasks (OT2), which includes at least one task. Examples of OT2 are:
1. In one example of OT2, the UE may avoid collision between data transmission in UL (e.g., during SR1 e.g. CG-SDT transmission) and reception of paging message in DL (e.g., during PR1 e.g. PO1) in time domain by postponing the SDT using the SDT resource. In other words, the data transmission during SR1 (e.g., CG-SDT transmission) is adapted to ensure that the data transmission (e.g., CG-SDT transmission) does not overlap with the paging reception in time. The overlapping can be fully overlapping (i.e., the CG-SDT transmission resources overlap fully in time with the paging reception resources in time) or partially overlapping (i.e., at least some of the resources of CG-SDT and paging reception overlap in time). Examples of the adaptation by postponing the data transmission in SDT resources are:
   a. In one example, the adaptation also includes the UE also applying an offset (O1) to the CG-SDT transmission occasion to avoid overlapping of CG-SDT transmission and paging reception in time.
   b. Another example of adaptation includes the UE transmitting the CG-SDT transmission at least O2 time resources after the closest paging reception occasion in time or at least O2 time resources before the closest paging reception occasion in time. Examples of O2 are M time resources such as, for example, M1 symbols, M2 slots, M3 subframes, etc.
   c. In another example, the adaptation includes the UE postponing the SDT in a future SDT resource that occurs after SR1 in time. In one specific example, the future SDT resource is the next SDT resource occurring after SR1 in time. In another specific example, the future SDT resource is any SDT resource occurring after SR1 in time and that does not meet any SPP condition.
2. In another example of OT2, the UE may avoid collision between data transmission in UL (e.g., during SR1 e.g. CG-SDT transmission) and reception of paging message in DL (e.g., during PR1 e.g. PO1) in time domain by discarding or dropping the data transmission using SDT resource. In this case, the UE discards the data and does not transmit the same data in any future time resource.
3. In another example of OT2, the UE avoids the collision between data transmission in UL (e.g., during SR1 e.g. CG-SDT transmission) and reception of paging message in DL (e.g., during PR1 e.g. PO1) in time domain by selecting or switching between different SDT methods configured for transmitting the data in SDT resources. For example, the UE may switch between CG-SDT and RACH-SDT methods. Examples of by selecting or switching between different SDT methods for the data transmission in SDT resources are:
   a. In one example, the UE selects one of the SDT methods for the data transmission which ensure that the paging reception will not be disrupted or interrupted e.g. the method which does not meet any of the SPP conditions.
      1. In one example, if at least one SPP is met for the data transmission using CG-SDT (e.g., SR1 is CG-SDT resource), then the UE selects RACH-SDT if the data transmission using the latter method will not lead to the interruption in paging reception.
      2. In another example, if at least one SPP is met for the data transmission using RACH-SDT (e.g., SR1 is RACH-SDT resource), then the UE selects CG-SDT if the data transmission using the latter method will not lead to the interruption in paging reception.
      3. In another example, if at least one SPP is met for the data transmission using 4-step RACH-SDT (e.g., SR1 is 4-step RACH-SDT resource), then the UE selects 2-step RACH-SDT if the data transmission using the latter method will not lead to the interruption in paging reception.
      4. In another example, if at least one SPP is met for the data transmission using 2-step RACH-SDT (e.g., SR1 is 2-step RACH-SDT resource), then the UE selects 4-step RACH-SDT if the data transmission using the latter method will not lead to the interruption in paging reception.
      5. The UE uses the selected SDT method for transmitting the data using the SDT resources provided that one or more criteria (if any) for using the selected SDT method are met (e.g., TA is valid, etc.). But, if none of the SDT methods can avoid interruption in paging reception, then the UE may apply the adaptation using another rule (e.g., postponing the data transmission, dropping the data transmission, etc.).
4. In another example of OT2, the UE may avoid collision between data transmission in UL (e.g., during SR1 e.g. CG-SDT transmission) and reception of paging message in DL (e.g., during PR1 e.g. PO1) in time domain by postponing the paging reception to a future paging resource. For example, the UE does not receive the paging during PR1 (e.g., PO1). For example, the UE may drop the paging during PR1 (e.g., PO1). The adaptation ensures that the data transmission (e.g., CG-SDT transmission) does not overlap with the paging reception in time. In one example, the UE does not even transmit data using SDT resource. In another example, the UE may further perform data transmission using SDT resource while postponing or discarding the paging reception. This latter mechanism may further allow the UE to prioritize the transmission of data using the SDT resource over the reception of paging in the paging resource. Examples of postponing the reception of the paging are:
   a. In one example, the UE postpones the paging reception in a future paging resource (e.g., next paging resource) occurring after PR1 in time.
   b. In another example, the UE postpones the paging reception in a future paging resource occurring certain time period (T11) after PR1 in time:
      i. In one example, T11 correspond to L11 number of paging reception resource periodicity (Tpr).
      ii. In another example, T11 correspond to L12 number of SDT resource periodicity (Tsr).
      iii. In another example, T11 correspond to certain number of time resources (e.g., N11 number of SFN cycles, N12 number of H-SFN cycles), etc.
   c. In another example, the UE postpones the paging reception in a future paging resource occurring after PR1 in time provided that the UE has not missed paging reception in more than L13 number of consecutive paging resources.
   d. In another example, the UE postpones the paging reception in a future paging resource occurring after PR1 in time provided that the UE has not missed paging reception in more than L14 number of paging resources during certain time period, T12.
   e. In another example, the UE postpones the paging reception in a future paging resource occurring after PR1 in time provided that the UE the missed paging reception probability (Pm) does not exceed a threshold associated with L14. Pm is defined as a ratio of the number of the missed paging receptions during time period, T13 to the total number of the paging resources configured for paging reception T13. Examples of L14 are 0.1%, 0.5%, etc.
   f. In another example, the UE does not receive paging during PR1. Instead, the network node may provide the paging-related information (e.g., short message indicating ETWS/CMAS notification, informing the UE that it had been paged during PR1, etc.) in a DL channel (e.g., PDSCH) transmitted in response to the UL data transmission during SR1.
   g. The parameters L11, L12, L12, L14, T11, T12 and T13 may be pre-defined or configured by the network node.
5. In another example, any of the above rules related to the UE adaptations may be applied based on any of: Tsr, Tpr, or a relation between Tsr and Tpr. This is described below with examples:
   a. In one example, the adaptation is applied when the SDT resource (e.g., CG-SDT) transmission periodicity is less than paging reception periodicity, i.e. Tsr<Tpr. Otherwise, the UE adapts the paging reception. The adaptation of the paging reception may include not receiving the paging in the paging resource (e.g., PR1), which meets the SPP condition. The UE may, however, receive paging in a future paging resource such as, for example, a paging occurring after PR1 in time. Here, Tsr<Tpr means that the SDT resource (e.g., CG-SDT) transmission periodicity occurs more frequently in time than the paging reception periodicity. By adapting the data transmission in the SDT resource (e.g., CG-SDT), the UE prioritizes the reception of paging message. The UE may further delay data transmission in the SDT resource and transmit the data in the SDT resource (e.g., CG-SDT data) in the next SDT occasion (e.g. SDT resource).
   b. In another example, the UE adapts the data transmission using SDT resource (e.g., CG-SDT transmission) only when Tsr<Tpr by a certain margin, i.e. Tsr< (Tpr+M11). Otherwise, the UE adapts the paging reception. The adaptation of the paging reception may include not receiving the paging in the paging resource (e.g., PR1), which meets the SPP condition. The UE may, however, receive paging in a future paging resource such as, for example, paging occurring after PR1 in time. Here, Tsr< (Tpr+M11) means the paging reception may happen quite infrequently (depending on the value of M11). In a situation like this, it is better to prioritize the reception of paging message and instead transmit the data using SDT resource (e.g. CG-SDT data) in the next occasion containing the SDT resource.
   c. In another example, the UE adapts the data transmission using SDT resource (e.g., CG-SDT transmission) only when Tsr<M12. Examples of M12 are 320 ms, 640 ms, etc. Otherwise, the UE adapts the paging reception. The adaptation of the paging reception may comprise not receiving the paging in the paging resource (e.g., PR1), which meets the SPP condition. The UE may, however, receive paging in a future paging resource such as, for example, paging occurring after PR1 in time.
   d. In another example, the UE adapts the data transmission using the SDT resource (e.g., CG-SDT transmission) only when Tpr<M13. Otherwise, the UE adapts the paging reception. The adaptation of the paging reception may include not receiving the paging in the paging resource (e.g., PR1) that meets the SPP condition. The UE may, however, receive paging in a future paging resource such as, for example, a paging occurring after PR1 in time.
   e. In another specific example, if the relation between Tsr and Tpr is such that they are identical, then in one example, the UE may always prioritize the transmission of data using SDT resource (e.g. CG-SDT) over paging reception. The motivation is that the network may transmit the paging message as part of the SDT feedback message (e.g., CG-SDT feedback message) in DL. In another example, if Tsr=Tpr, then the UE may always prioritize the paging reception over the data transmission using SDT resource.
   f. In the above examples, M11, M12, and M13 can be predefined, preconfigured or configured by the network node. The values may also depend on the numerology of the signal of SDT resource and/or paging reception resource (e.g., subcarrier spacing, the cyclic prefix, length of time resource (e.g. slot length), etc.).
6. In another example of OT2, the UE may avoid collision between data transmission in UL (e.g., during SR1 e.g. CG-SDT transmission) and reception of paging message in DL (e.g., during PR1 e.g. PO1) in time domain by postponing or discarding the data transmission using SDT resource, while receiving at least one signal related to the paging in at least one paging resource. This mechanism allows the UE to prioritize the reception of paging over the transmission of data using the SDT resource. Examples of signals related to paging are reference signal (e.g., SSB, CSI-RS, Tracking reference signal (TRS), etc.) associated with paging (e.g., RS used by UE for time-frequency tracking or synchronization before paging reception, etc.), paging control channel (e.g., paging DCI, DL control channel, PDCCH, etc.), paging data channel (e.g. PDSCH carrying paging message, etc.), etc.

In one example, if UE meets the SPP condition secondly before UE completes a second set of operational tasks (OT2) with regard to the first SPP condition, UE shall complete OT2 for the first SPP condition and continue OT2 for the second SSP condition.

In another example, the UE prioritizes (or adapts) the transmission of data using SDT resource (e.g., CG-SDT) over paging reception, or vice-versa, depending on the priority of the UL data to be transmitted using the SDT resource. In one specific example, if the UL data has very high priority (e.g., UL data from a safety related sensor), the UE transmits using the SDT resource and adapts the reception of paging (e.g., does not receive paging). In another specific example, if the UL data has very low priority, the UE receives the paging message and adapts the data transmission using SDT resource (e.g., UE postpones the data transmission in a future SDT resource).

In another example, irrespective of whether the UE meets the SPP conditions or not, the UE adapts the transmission of data using the SDT resource (e.g., CG-SDT) based on the presence or absence of UL data in the UE's buffer. More specifically, if there is no data in the UE's buffer until T1-M14, where T1 indicates the start of SDT time resources, such as shown in FIG. 1 and FIG. 2, and M14 is some margin that can be predefined, preconfigured or configured by the network node, the UE always receives the paging message. The adaptation of data transmission in this example may include not transmitting “dummy” bits using the SDT resource, skipping the SDT resource, etc.

The UE may also be explicitly or implicitly indicated in the CG-SDT configuration(s) to perform one or more of the operational tasks in the sets OT1 and/or OT2 depending on the SPP conditions met by the UE. Since a UE can be provided with multiple CG-SDT configurations, the tasks to be performed by the UE can be common for multiple CG-SDT configurations or they can be specific to a CG-SDT configuration. For example, different CG-SDT configurations may correspond to UL data with different priorities. If the UL data corresponding to a CG-SDT configuration has a very high priority, the UE may be indicated in the CG-SDT configuration to always prioritize the data transmission in the CG-SDT resource over the reception of the paging message. On the other hand, if the UL data has a very low priority, the UE may be indicated to always prioritize the reception of the paging message over the data transmission in the CG-SDT resource.

The UE may account to the network (i.e., report to a network node) the number of occurrences of SPP or trigger to OT2. The UE also can indicate the number to the network in the SDT or PUSCH transmission. In one example, when the accounted number (ANI) of occurrences of SPP in certain time (AC1) is greater than threshold (AT1), the network may reconfigure one or more SDT resources and/or paging reception resources for the UE. In another example, when the accounted number (ANI) of occurrences of SPP in certain time (AC2) is lower than threshold (AT2), the network keeps the SDT resource and/or paging reception resource for the UE, or isn't aware of correspondence between SDT resource and paging reception resource for the UE.

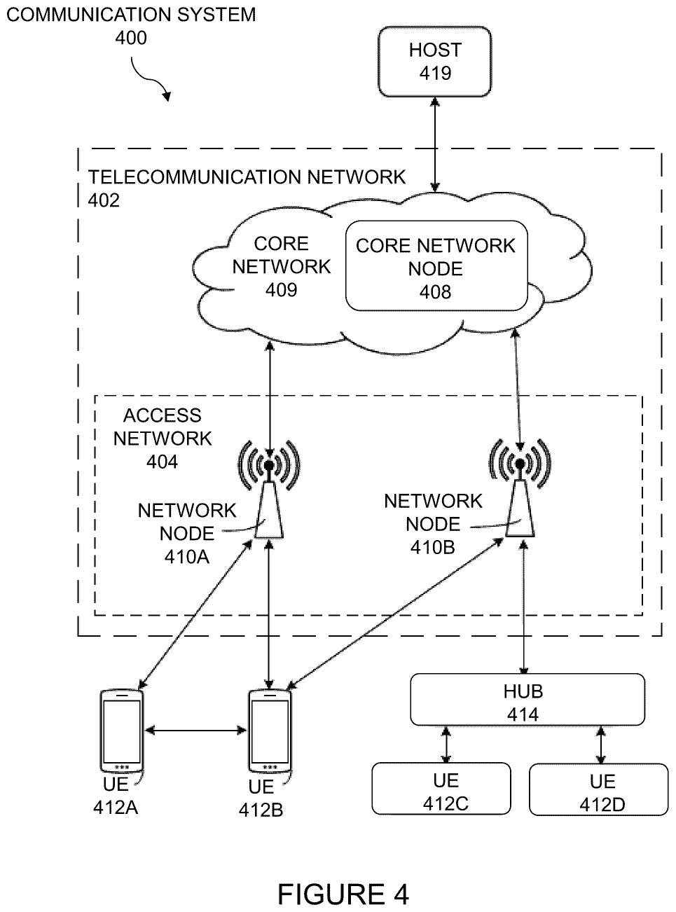

FIG. 4 shows an example of a communication system 400 in accordance with some embodiments. In the example, the communication system 400 includes a telecommunication network 402 that includes an access network 404, such as a radio access network (RAN), and a core network 406, which includes one or more core network nodes 408. The access network 404 includes one or more access network nodes, such as network nodes 410a and 410b (one or more of which may be generally referred to as network nodes 410), or any other similar 3rd Generation Partnership Project (3GPP) access node or non-3GPP access point. The network nodes 410 facilitate direct or indirect connection of user equipment (UE), such as by connecting UEs 412a, 412b, 412c, and 412d (one or more of which may be generally referred to as UEs 412) to the core network 406 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 400 may include any number of wired or wireless networks, network nodes, UEs, and/or any other components or systems that may facilitate or participate in the communication of data and/or signals whether via wired or wireless connections. The communication system 400 may include and/or interface with any type of communication, telecommunication, data, cellular, radio network, and/or other similar type of system.

The UEs 412 may be any of a wide variety of communication devices, including wireless devices arranged, configured, and/or operable to communicate wirelessly with the network nodes 410 and other communication devices. Similarly, the network nodes 410 are arranged, capable, configured, and/or operable to communicate directly or indirectly with the UEs 412 and/or with other network nodes or equipment in the telecommunication network 402 to enable and/or provide network access, such as wireless network access, and/or to perform other functions, such as administration in the telecommunication network 402.

In the depicted example, the core network 406 connects the network nodes 410 to one or more hosts, such as host 416. These connections may be direct or indirect via one or more intermediary networks or devices. In other examples, network nodes may be directly coupled to hosts. The core network 406 includes one more core network nodes (e.g., core network node 408) that are structured with hardware and software components. Features of these components may be substantially similar to those described with respect to the UEs, network nodes, and/or hosts, such that the descriptions thereof are generally applicable to the corresponding components of the core network node 408. Example core network nodes include functions of one or more of a Mobile Switching Center (MSC). Mobility Management Entity (MME). Home Subscriber Server (HSS). Access and Mobility Management Function (AMF). Session Management Function (SMF). Authentication Server Function (AUSF). Subscription Identifier De-concealing function (SIDF). Unified Data Management (UDM). Security Edge Protection Proxy (SEPP). Network Exposure Function (NEF), and/or a User Plane Function (UPF).

The host 416 may be under the ownership or control of a service provider other than an operator or provider of the access network 404 and/or the telecommunication network 402, and may be operated by the service provider or on behalf of the service provider. The host 416 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 400 of FIG. 4 enables connectivity between the UEs, network nodes, and hosts. In that sense, the communication system may be configured to operate according to predefined rules or procedures, such as specific standards that include, but are not limited to: Global System for Mobile Communications (GSM): Universal Mobile Telecommunications System (UMTS): Long Term Evolution (LTE), and/or other suitable 2G. 3G. 4G. 5G standards, or any applicable future generation standard (e.g., 6G): wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax). Bluetooth. Z-Wave. Near Field Communication (NFC) ZigBee. LiFi, and/or any low-power wide-area network (LPWAN) standards such as LoRa and Sigfox.

In some examples, the telecommunication network 402 is a cellular network that implements 3GPP standardized features. Accordingly, the telecommunications network 402 may support network slicing to provide different logical networks to different devices that are connected to the telecommunication network 402. For example, the telecommunications network 402 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 412 are configured to transmit and/or receive information without direct human interaction. For instance, a UE may be designed to transmit information to the access network 404 on a predetermined schedule, when triggered by an internal or external event, or in response to requests from the access network 404. Additionally, a UE may be configured for operating in single- or multi-RAT or multi-standard mode. For example, a UE may operate with any one or combination of Wi-Fi. NR (New Radio) and LTE. i.e. being configured for multi-radio dual connectivity (MR-DC), such as E-UTRAN (Evolved-UMTS Terrestrial Radio Access Network) New Radio-Dual Connectivity (EN-DC).

In the example, the hub 414 communicates with the access network 404 to facilitate indirect communication between one or more UEs (e.g., UE 412c and/or 412d) and network nodes (e.g., network node 410b). In some examples, the hub 414 may be a controller, router, content source and analytics, or any of the other communication devices described herein regarding UEs. For example, the hub 414 may be a broadband router enabling access to the core network 406 for the UEs. As another example, the hub 414 may be a controller that sends commands or instructions to one or more actuators in the UEs. Commands or instructions may be received from the UEs.

network nodes 410, or by executable code, script, process, or other instructions in the hub 414. As another example, the hub 414 may be a data collector that acts as temporary storage for UE data and, in some embodiments, may perform analysis or other processing of the data. As another example, the hub 414 may be a content source. For example, for a UE that is a VR headset, display, loudspeaker or other media delivery device, the hub 414 may retrieve VR assets, video, audio, or other media or data related to sensory information via a network node, which the hub 414 then provides to the UE either directly, after performing local processing, and/or after adding additional local content. In still another example, the hub 414 acts as a proxy server or orchestrator for the UEs, in particular in if one or more of the UEs are low energy IoT devices.

The hub 414 may have a constant/persistent or intermittent connection to the network node 410b. The hub 414 may also allow for a different communication scheme and/or schedule between the hub 414 and UEs (e.g., UE 412c and/or 412d), and between the hub 414 and the core network 406. In other examples, the hub 414 is connected to the core network 406 and/or one or more UEs via a wired connection. Moreover, the hub 414 may be configured to connect to an M2M service provider over the access network 404 and/or to another UE over a direct connection. In some scenarios. UEs may establish a wireless connection with the network nodes 410 while still connected via the hub 414 via a wired or wireless connection. In some embodiments, the hub 414 may be a dedicated hub—that is, a hub whose primary function is to route communications to/from the UEs from/to the network node 410b. In other embodiments, the hub 414 may be a non-dedicated hub—that is, a device which is capable of operating to route communications between the UEs and network node 410b, but which is additionally capable of operating as a communication start and/or end point for certain data channels.

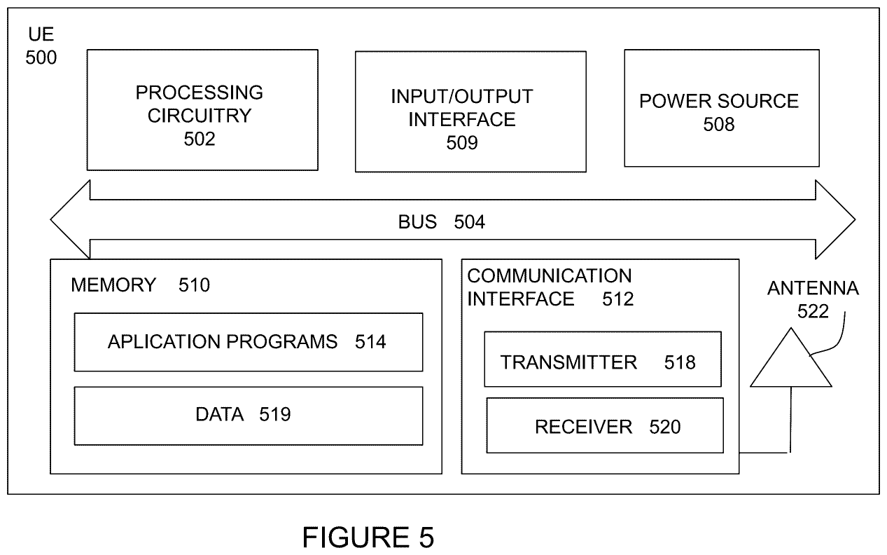

FIG. 5 shows a UE 500 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication. Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 500 includes processing circuitry 502 that is operatively coupled via a bus 504 to an input/output interface 506, a power source 508, a memory 510, a communication interface 512, and/or any other component, or any combination thereof. Certain UEs may utilize all or a subset of the components shown in FIG. 5. The level of integration between the components may vary from one UE to another UE. Further, certain UEs may contain multiple instances of a component, such as multiple processors, memories, transceivers, transmitters, receivers, etc.

The processing circuitry 502 is configured to process instructions and data and may be configured to implement any sequential state machine operative to execute instructions stored as machine-readable computer programs in the memory 510. The processing circuitry 502 may be implemented as one or more hardware-implemented state machines (e.g., in discrete logic, field-programmable gate arrays (FPGAs), application specific integrated circuits (ASICs), etc.): programmable logic together with appropriate firmware: one or more stored computer programs, general-purpose processors, such as a microprocessor or digital signal processor (DSP), together with appropriate software; or any combination of the above. For example, the processing circuitry 502 may include multiple central processing units (CPUs).

In the example, the input/output interface 506 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof.

An input device may allow a user to capture information into the UE 500. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 508 is structured as a battery or battery pack.

Other types of power sources, such as an external power source (e.g., an electricity outlet), photovoltaic device, or power cell, may be used. The power source 508 may further include power circuitry for delivering power from the power source 508 itself, and/or an external power source, to the various parts of the UE 500 via input circuitry or an interface such as an electrical power cable. Delivering power may be, for example, for charging of the power source 508. Power circuitry may perform any formatting, converting, or other modification to the power from the power source 508 to make the power suitable for the respective components of the UE 500 to which power is supplied.

The memory 510 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 510 includes one or more application programs 514, such as an operating system, web browser application, a widget, gadget engine, or other application, and corresponding data 516. The memory 510 may store, for use by the UE 500, any of a variety of various operating systems or combinations of operating systems.

The memory 510 may be configured to include a number of physical drive units, such as redundant array of independent disks (RAID), flash memory. USB flash drive, external hard disk drive, thumb drive, pen drive, key drive, high-density digital versatile disc (HD-DVD) optical disc drive, internal hard disk drive. Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as SIM card. The memory 510 may allow the UE 500 to access instructions, application programs and the like, stored on transitory or non-transitory memory media, to off-load data, or to upload data. An article of manufacture, such as one utilizing a communication system may be tangibly embodied as or in the memory 510, which may be or comprise a device-readable storage medium.

The processing circuitry 502 may be configured to communicate with an access network or other network using the communication interface 512. The communication interface 512 may comprise one or more communication subsystems and may include or be communicatively coupled to an antenna 522. The communication interface 512 may include one or more transceivers used to communicate, such as by communicating with one or more remote transceivers of another device capable of wireless communication (e.g., another UE or a network node in an access network). Each transceiver may include a transmitter 518 and/or a receiver 520 appropriate to provide network communications (e.g., optical, electrical, frequency allocations, and so forth). Moreover, the transmitter 518 and receiver 520 may be coupled to one or more antennas (e.g., antenna 522) and may share circuit components, software or firmware, or alternatively be implemented separately.

In the illustrated embodiment, communication functions of the communication interface 512 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 512, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 500 shown in FIG. 5.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

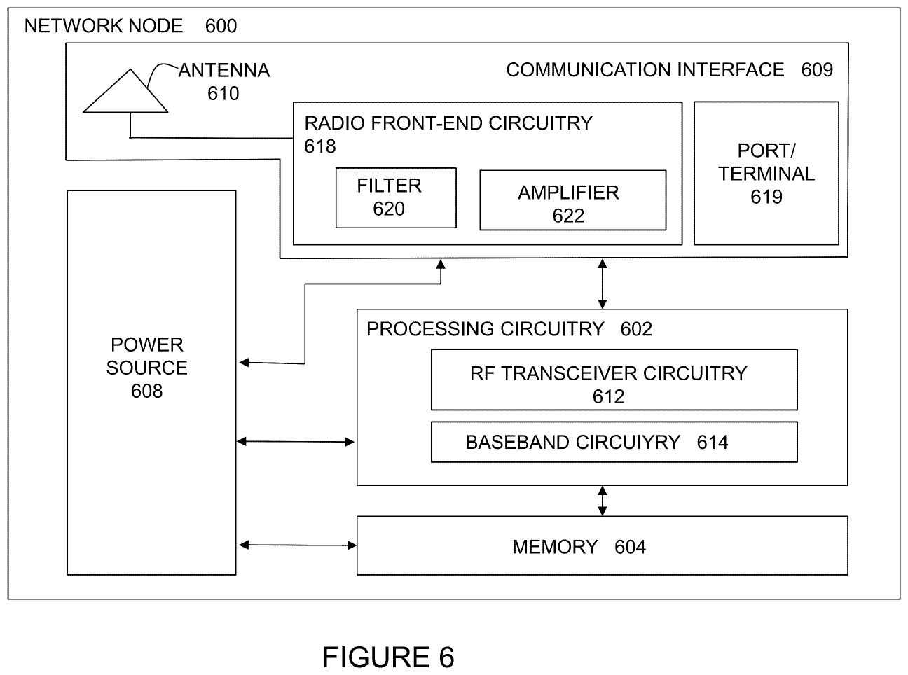

FIG. 6 shows a network node 600 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs). Operation and Maintenance (O&M) nodes. Operations Support System (OSS) nodes. Self-Organizing Network (SON) nodes, positioning nodes (e.g., Evolved Serving Mobile Location Centers (E-SMLCs)), and/or Minimization of Drive Tests (MDTs).

The network node 600 includes a processing circuitry 602, a memory 604, a communication interface 606, and a power source 608. The network node 600 may be composed of multiple physically separate components (e.g., a NodeB component and a RNC component, or a BTS component and a BSC component, etc.), which may each have their own respective components. In certain scenarios in which the network node 600 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 600 may be configured to support multiple radio access technologies (RATs). In such embodiments, some components may be duplicated (e.g., separate memory 604 for different RATs) and some components may be reused (e.g., a same antenna 610) may be shared by different RATs). The network node 600 may also include multiple sets of the various illustrated components for different wireless technologies integrated into network node 600, for example GSM. WCDMA. LTE. NR. WiFi. Zigbee. Z-wave. LoRaWAN. Radio Frequency Identification (RFID) or Bluetooth wireless technologies. These wireless technologies may be integrated into the same or different chip or set of chips and other components within network node 600.

The processing circuitry 602 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 600 components, such as the memory 604, to provide network node 600 functionality.

In some embodiments, the processing circuitry 602 includes a system on a chip (SOC). In some embodiments, the processing circuitry 602 includes one or more of radio frequency (RF) transceiver circuitry 612 and baseband processing circuitry 614. In some embodiments, the radio frequency (RF) transceiver circuitry 612 and the baseband processing circuitry 614 may be on separate chips (or sets of chips), boards, or units, such as radio units and digital units. In alternative embodiments, part or all of RF transceiver circuitry 612 and baseband processing circuitry 614 may be on the same chip or set of chips, boards, or units.

The memory 604 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 602. The memory 604 may store any suitable instructions, data, or information, including a computer program, software, an application including one or more of logic, rules, code, tables, and/or other instructions capable of being executed by the processing circuitry 602 and utilized by the network node 600. The memory 604 may be used to store any calculations made by the processing circuitry 602 and/or any data received via the communication interface 606. In some embodiments, the processing circuitry 602 and memory 604 is integrated.

The communication interface 606 is used in wired or wireless communication of signaling and/or data between a network node, access network, and/or UE. As illustrated, the communication interface 606 comprises port(s)/terminal(s) 616 to send and receive data, for example to and from a network over a wired connection. The communication interface 606 also includes radio front-end circuitry 618 that may be coupled to, or in certain embodiments a part of, the antenna 610. Radio front-end circuitry 618 comprises filters 620 and amplifiers 622. The radio front-end circuitry 618 may be connected to an antenna 610 and processing circuitry 602. The radio front-end circuitry may be configured to condition signals communicated between antenna 610) and processing circuitry 602. The radio front-end circuitry 618 may receive digital data that is to be sent out to other network nodes or UEs via a wireless connection. The radio front-end circuitry 618 may convert the digital data into a radio signal having the appropriate channel and bandwidth parameters using a combination of filters 620 and/or amplifiers 622. The radio signal may then be transmitted via the antenna 610. Similarly, when receiving data, the antenna 610 may collect radio signals which are then converted into digital data by the radio front-end circuitry 618. The digital data may be passed to the processing circuitry 602. In other embodiments, the communication interface may comprise different components and/or different combinations of components.

In certain alternative embodiments, the network node 600 does not include separate radio front-end circuitry 618, instead, the processing circuitry 602 includes radio front-end circuitry and is connected to the antenna 610. Similarly, in some embodiments, all or some of the RF transceiver circuitry 612 is part of the communication interface 606. In still other embodiments, the communication interface 606 includes one or more ports or terminals 616, the radio front-end circuitry 618, and the RF transceiver circuitry 612, as part of a radio unit (not shown), and the communication interface 606 communicates with the baseband processing circuitry 614, which is part of a digital unit (not shown).

The antenna 610 may include one or more antennas, or antenna arrays, configured to send and/or receive wireless signals. The antenna 610 may be coupled to the radio front-end circuitry 618 and may be any type of antenna capable of transmitting and receiving data and/or signals wirelessly. In certain embodiments, the antenna 610 is separate from the network node 600 and connectable to the network node 600 through an interface or port.

The antenna 610, communication interface 606, and/or the processing circuitry 602 may be configured to perform any receiving operations and/or certain obtaining operations described herein as being performed by the network node. Any information, data and/or signals may be received from a UE, another network node and/or any other network equipment. Similarly, the antenna 610, the communication interface 606, and/or the processing circuitry 602 may be configured to perform any transmitting operations described herein as being performed by the network node. Any information, data and/or signals may be transmitted to a UE, another network node and/or any other network equipment.

The power source 608 provides power to the various components of network node 600 in a form suitable for the respective components (e.g., at a voltage and current level needed for each respective component). The power source 608 may further comprise, or be coupled to, power management circuitry to supply the components of the network node 600 with power for performing the functionality described herein. For example, the network node 600 may be connectable to an external power source (e.g., the power grid, an electricity outlet) via an input circuitry or interface such as an electrical cable, whereby the external power source supplies power to power circuitry of the power source 608. As a further example, the power source 608 may comprise a source of power in the form of a battery or battery pack which is connected to, or integrated in, power circuitry. The battery may provide backup power should the external power source fail.

Embodiments of the network node 600 may include additional components beyond those shown in FIG. 6 for providing certain aspects of the network node's functionality, including any of the functionality described herein and/or any functionality necessary to support the subject matter described herein. For example, the network node 600 may include user interface equipment to allow input of information into the network node 600 and to allow output of information from the network node 600. This may allow a user to perform diagnostic, maintenance, repair, and other administrative functions for the network node 600.

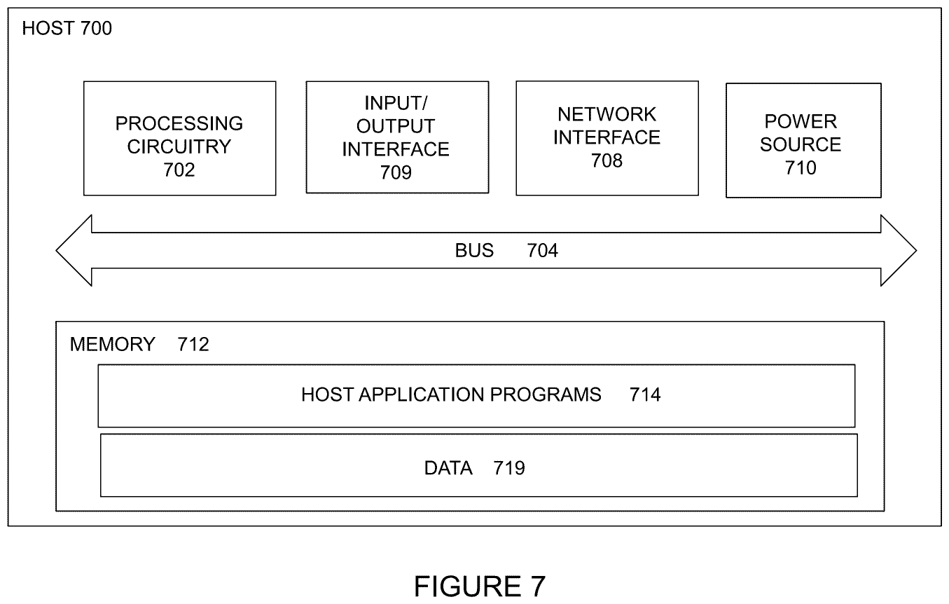

FIG. 7 is a block diagram of a host 700, which may be an embodiment of the host 416 of FIG. 4, in accordance with various aspects described herein.

As used herein, the host 700 may be or comprise various combinations hardware and/or software, including a standalone server, a blade server, a cloud-implemented server, a distributed server, a virtual machine, container, or processing resources in a server farm. The host 700 may provide one or more services to one or more UEs.

The host 700 includes processing circuitry 702 that is operatively coupled via a bus 704 to an input/output interface 706, a network interface 708, a power source 710, and a memory 712. Other components may be included in other embodiments. Features of these components may be substantially similar to those described with respect to the devices of previous figures, such as FIGS. 5 and 6, such that the descriptions thereof are generally applicable to the corresponding components of host 700.

The memory 712 may include one or more computer programs including one or more host application programs 714 and data 716, which may include user data, e.g., data generated by a UE for the host 700 or data generated by the host 700 for a UE. Embodiments of the host 700 may utilize only a subset or all of the components shown. The host application programs 714 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 714 may also provide for user authentication and licensing checks and may periodically report health, routes, and content availability to a central node, such as a device in or on the edge of a core network. Accordingly, the host 700 may select and/or indicate a different host for over-the-top services for a UE. The host application programs 714 may support various protocols, such as the HTTP Live Streaming (HLS) protocol, Real-Time Messaging Protocol (RTMP), Real-Time Streaming Protocol (RTSP), Dynamic Adaptive Streaming over HTTP

(MPEG-DASH), etc.

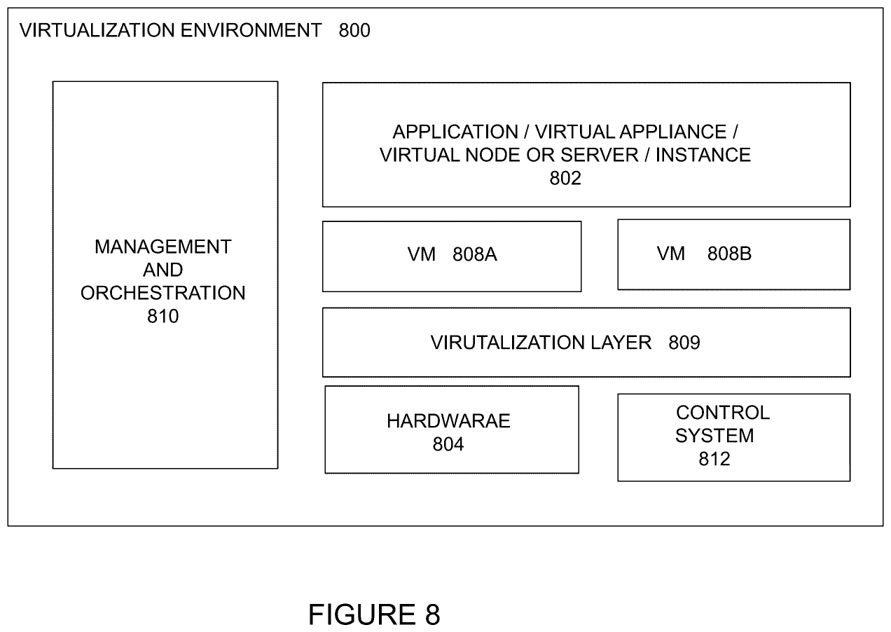

FIG. 8 is a block diagram illustrating a virtualization environment 800 in which functions implemented by some embodiments may be virtualized.

In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 800 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 802 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 804 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 806 (also referred to as hypervisors or virtual machine monitors (VMMs)), provide VMs 808a and 808b (one or more of which may be generally referred to as VMs 808), and/or perform any of the functions, features and/or benefits described in relation with some embodiments described herein.

The virtualization layer 806 may present a virtual operating platform that appears like networking hardware to the VMs 808.

The VMs 808 comprise virtual processing, virtual memory, virtual networking or interface and virtual storage, and may be run by a corresponding virtualization layer 806. Different embodiments of the instance of a virtual appliance 802 may be implemented on one or more of VMs 808, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 808 may be a software implementation of a physical machine that runs programs as if they were executing on a physical, non-virtualized machine. Each of the VMs 808, and that part of hardware 804 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 808 on top of the hardware 804 and corresponds to the application 802.

Hardware 804 may be implemented in a standalone network node with generic or specific components. Hardware 804 may implement some functions via virtualization. Alternatively, hardware 804 may be part of a larger cluster of hardware (e.g, such as in a data center or CPE) where many hardware nodes work together and are managed via management and orchestration 810, which, among others, oversees lifecycle management of applications 802. In some embodiments, hardware 804 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 812 which may alternatively be used for communication between hardware nodes and radio units.

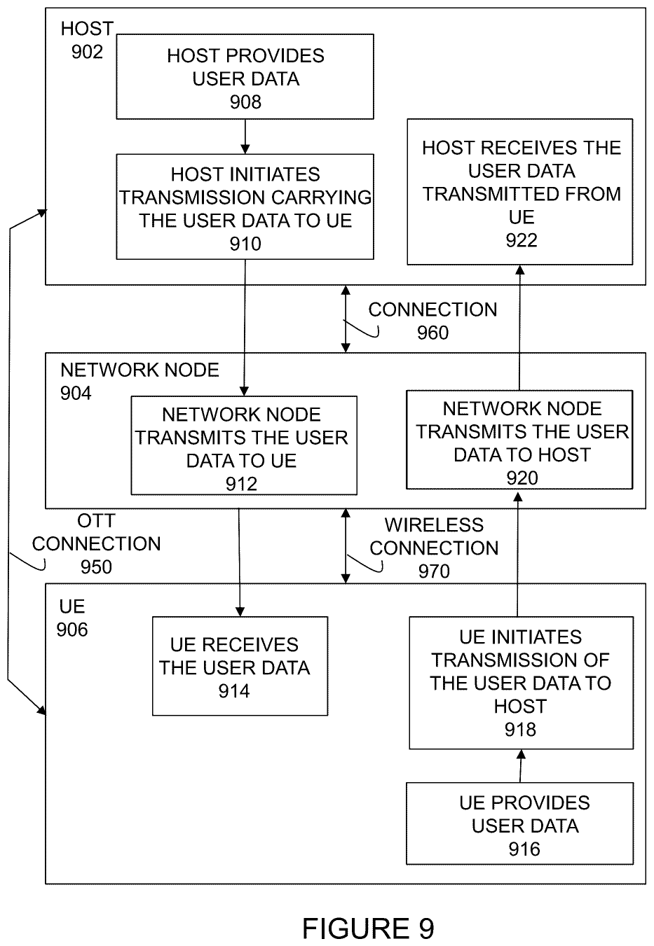

FIG. 9 shows a communication diagram of a host 902 communicating via a network node 904 with a UE 906 over a partially wireless connection in accordance with some embodiments. Example implementations, in accordance with various embodiments, of the UE (such as a UE 412a of FIG. 4 and/or UE 500 of FIG. 5), network node (such as network node 410a of FIG. 4 and/or network node 600 of FIG. 6), and host (such as host 416 of FIG. 4 and/or host 700 of FIG. 7) discussed in the preceding paragraphs will now be described with reference to FIG. 9.

Like host 700, embodiments of host 902 include hardware, such as a communication interface, processing circuitry, and memory. The host 902 also includes software, which is stored in or accessible by the host 902 and executable by the processing circuitry. The software includes a host application that may be operable to provide a service to a remote user, such as the UE 906 connecting via an over-the-top (OTT) connection 950 extending between the UE 906 and host 902. In providing the service to the remote user, a host application may provide user data which is transmitted using the OTT connection 950.

The network node 904 includes hardware enabling it to communicate with the host 902 and UE 906. The connection 960 may be direct or pass through a core network (like core network 406 of FIG. 4) and/or one or more other intermediate networks, such as one or more public, private, or hosted networks. For example, an intermediate network may be a backbone network or the Internet.

The UE 906 includes hardware and software, which is stored in or accessible by UE 906 and executable by the UE's processing circuitry. The software includes a client application, such as a web browser or operator-specific “app” that may be operable to provide a service to a human or non-human user via UE 906 with the support of the host 902. In the host 902, an executing host application may communicate with the executing client application via the OTT connection 950 terminating at the UE 906 and host 902. In providing the service to the user, the UE's client application may receive request data from the host's host application and provide user data in response to the request data. The OTT connection 950 may transfer both the request data and the user data. The UE's client application may interact with the user to generate the user data that it provides to the host application through the OTT connection 950.

The OTT connection 950 may extend via a connection 960 between the host 902 and the network node 904 and via a wireless connection 970 between the network node 904 and the UE 906 to provide the connection between the host 902 and the UE 906. The connection 960 and wireless connection 970, over which the OTT connection 950 may be provided, have been drawn abstractly to illustrate the communication between the host 902 and the UE 906 via the network node 904, without explicit reference to any intermediary devices and the precise routing of messages via these devices.

As an example of transmitting data via the OTT connection 950, in step 908, the host 902 provides user data, which may be performed by executing a host application. In some embodiments, the user data is associated with a particular human user interacting with the UE 906. In other embodiments, the user data is associated with a UE 906 that shares data with the host 902 without explicit human interaction. In step 910, the host 902 initiates a transmission carrying the user data towards the UE 906. The host 902 may initiate the transmission responsive to a request transmitted by the UE 906. The request may be caused by human interaction with the UE 906 or by operation of the client application executing on the UE 906. The transmission may pass via the network node 904, in accordance with the teachings of the embodiments described throughout this disclosure. Accordingly, in step 912, the network node 904 transmits to the UE 906 the user data that was carried in the transmission that the host 902 initiated, in accordance with the teachings of the embodiments described throughout this disclosure. In step 914, the UE 906 receives the user data carried in the transmission, which may be performed by a client application executed on the UE 906 associated with the host application executed by the host 902.

In some examples, the UE 906 executes a client application which provides user data to the host 902. The user data may be provided in reaction or response to the data received from the host 902. Accordingly, in step 916, the UE 906 may provide user data, which may be performed by executing the client application. In providing the user data, the client application may further consider user input received from the user via an input/output interface of the UE 906. Regardless of the specific manner in which the user data was provided, the UE 906 initiates, in step 918, transmission of the user data towards the host 902 via the network node 904. In step 920, in accordance with the teachings of the embodiments described throughout this disclosure, the network node 904 receives user data from the UE 906 and initiates transmission of the received user data towards the host 902. In step 922, the host 902 receives the user data carried in the transmission initiated by the UE 906.

One or more of the various embodiments improve the performance of OTT services provided to the UE 906 using the OTT connection 950, in which the wireless connection 970 forms the last segment. More precisely, the teachings of these embodiments may improve one or more of, for example, data rate, latency, and/or power consumption and, thereby, provide benefits such as, for example, reduced user waiting time, relaxed restriction on file size, improved content resolution, better responsiveness, and/or extended battery lifetime.

In an example scenario, factory status information may be collected and analyzed by the host 902. As another example, the host 902 may process audio and video data which may have been retrieved from a UE for use in creating maps. As another example, the host 902 may collect and analyze real-time data to assist in controlling vehicle congestion (e.g., controlling traffic lights). As another example, the host 902 may store surveillance video uploaded by a UE. As another example, the host 902 may store or control access to media content such as video, audio, VR or AR which it can broadcast, multicast or unicast to UEs. As other examples, the host 902 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 950 between the host 902 and UE 906, in response to variations in the measurement results. The measurement procedure and/or the network functionality for reconfiguring the OTT connection may be implemented in software and hardware of the host 902 and/or UE 906. In some embodiments, sensors (not shown) may be deployed in or in association with other devices through which the OTT connection 950 passes: the sensors may participate in the measurement procedure by supplying values of the monitored quantities exemplified above, or supplying values of other physical quantities from which software may compute or estimate the monitored quantities. The reconfiguring of the OTT connection 950 may include message format, retransmission settings, preferred routing etc.: the reconfiguring need not directly alter the operation of the network node 904. Such procedures and functionalities may be known and practiced in the art. In certain embodiments, measurements may involve proprietary UE signaling that facilitates measurements of throughput, propagation times, latency and the like, by the host 902. The measurements may be implemented in that software causes messages to be transmitted, in particular empty or ‘dummy’ messages, using the OTT connection 950 while monitoring propagation times, errors, etc.

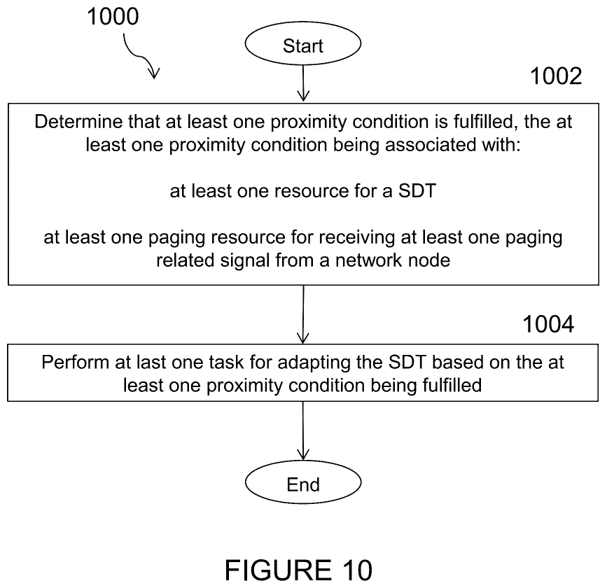

FIG. 10 illustrates an example method 1000 by a UE (412A-D) for adapting a SDT, according to embodiments. As illustrated, the method includes determining, at step 1002, that at least one proximity condition is fulfilled. The at least one proximity condition is associated with at least one resource for a SDT and at least one paging resource for receiving at least one paging related signal from a network node. At step 1004, the UE performs at least one task for adapting the SDT based on the at least one proximity condition being fulfilled.

In a particular embodiment, determining that the at least one proximity condition is fulfilled includes determining that the at least one resource for the SDT at least partially overlaps in time with the at least one paging resource.

In a particular embodiment, performing the at least one task for adapting the SDT based on the at least one proximity condition being fulfilled includes at least one of: monitoring at least one paging occasion associated with the at least one paging resource, and receiving at least one paging related signal.

In a particular embodiment, performing the at least one task for adapting the SDT based on the at least one proximity condition being fulfilled includes dropping the SDT.

In a particular embodiment, performing the at least one task for adapting the SDT based on the at least one proximity condition being fulfilled includes at least one of postponing the SDT; and switching from a first SDT method to a second SDT method.

In a particular embodiment, switching from the first SDT method to the second SDT method includes: switching from a CG-SDT method to a RACH-SDT method: switching from a RACH-SDT method to a CG-SDT method: switching from a 4-step RACH-SDT method to a 2-step RACH-SDT method; or switching from a 2-step RACH-SDT method to a 4-step RACH-SDT method.

In a particular embodiment, the UE receives, from a network node, information associated with the at least one resource for a SDT.

In a further particular embodiment, the information associated with the at least one resource for the SDT comprises at least one of: a PUSCH allocation: a RACH allocation: a frequency of a pre-configured radio resource: information indicating that the at least one resource for the SDT is periodic and/or a periodicity of the at least one resource for the SDT: information indicating that the at least one resource for the SDT is aperiodic; and a TA value associated with a pre-configured radio resource.

In a particular embodiment, the at least one resource for the SDT is associated with a CG. In a particular embodiment, the UE receives, from a network node, information associated with the at least one paging reception resource.

In a further particular embodiment, the information associated with the at least one paging reception resource comprises a paging configuration and/or a paging reception periodicity.

In a particular embodiment, the UE determines that the UE has data to transmit using the at least one resource for the SDT.

In a further particular embodiment, determining that the UE has the data to transmit comprises at least one of: receiving data for transmission as SDT: determining that a buffer contains data: determining a need to retransmit previously transmitted data: receiving a request from a network node; and determining that a timer has expired.

In a further particular embodiment, the data for the SDT comprises at least one of: user data, control information, and a signaling message.

In a particular embodiment, determining that the at least one proximity condition is fulfilled includes determining that an amount of time between the at least one resource for the SDT and the at least one paging resource is less than a threshold.

In a particular embodiment, determining that the at least one proximity condition is fulfilled includes determining that at least one condition related to a periodicity, Tsr, of the at least one resource for the SDT is met.

In a particular embodiment, determining that the at least one proximity condition is fulfilled includes determining that at least one condition related to a periodicity, Tpr, of the at least one paging resource is met.

In a particular embodiment, determining that the at least one proximity condition is fulfilled includes determining a relationship between a periodicity of the at least one resource for the SDT. Tsr, and a periodicity of the at least one paging resource, Tpr; and determining that the relationship fulfills at least one condition.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### EXAMPLE EMBODIMENTS

### Group A Example Embodiments

Example Embodiment A1. A method by a user equipment for adapting a small data transmission (SDT) and/or paging reception, the method comprising: any of the user equipment steps, features, or functions described above, either alone or in combination with other steps, features, or functions described above.

Example Embodiment A2. The method of the previous embodiment, further comprising one or more additional user equipment steps, features or functions described above.

Example Embodiment A3. The method of any of the previous embodiments, further comprising: providing user data; and forwarding the user data to a host computer via the transmission to the network node.

### Group B Example Embodiments

Example Embodiment B1. A method performed by a network node for adapting a small data transmission (SDT) and/or paging reception, the method comprising: any of the network node steps, features, or functions described above, either alone or in combination with other steps, features, or functions described above.

Example Embodiment B2. The method of the previous embodiment, further comprising one or more additional network node steps, features or functions described above.

Example Embodiment B3. The method of any of the previous embodiments, further comprising: obtaining user data; and forwarding the user data to a host or a user equipment.

### Group C Example Embodiments

Example Embodiment C1. A method by a user equipment (UE) for adapting a small data transmission (SDT) and/or paging reception, the method comprising: determining that at least one proximity condition is fulfilled, the at least one proximity condition being associated with: at least one resource for a small data transmission (SDT), and at least one paging resource for receiving at least one paging related signal from a network node; and performing at least one task based on the at least one proximity condition being fulfilled.

Example Embodiment C2a. The method of Example Embodiment C1, further comprising obtaining information associated with the at least one resource for a SDT.

Example Embodiment C2b. The method of Example Embodiment C2a, wherein the information associated with the at least one resource for the SDT comprises at least one of: a PUSCH allocation: a RACH allocation: a frequency of a pre-configured radio resource: whether the at least one resource for the SDT is periodic and/or a periodicity of the at least one resource for the SDT: whether the at least one resource for the SDT is aperiodic; and a TA value associated with a pre-configured radio resource.

Example Embodiment C2c. The method of Example Embodiment C2b, wherein the at least one resource for the SDT is associated with a configured grant (CG).

Example Embodiment C2d. The method of any one of Example Embodiments C2a to C2c, wherein obtaining the information associated with the at least one resource for the SDT comprises receiving the information from a network node.

Example Embodiment C3a. The method of any one of Example Embodiments C1 to C2d, further comprising obtaining information associated with at least one paging reception resource.

Example Embodiment C3b. The method of Example Embodiment C3a, wherein the information associated with the at least one paging reception resource comprises a paging configuration.

Example Embodiment C3c. The method of Example Embodiment C3b, wherein the paging configuration comprises a paging reception periodicity.

Example Embodiment C4. The method of any one of Example Embodiments C1 to C3c, further comprising determining that the UE has data to transmit using the at least one resource for the SDT.

Example Embodiment C5. The method of Example Embodiment C4, wherein determining that the UE has the data to transmit comprises at least one of: receiving data for transmission as SDT: determining that a buffer contains data: determining a need to retransmit previously transmitted data: receiving a request from a network node; and determining that a timer has expired.

Example Embodiment C6. The method of any one of Example Embodiments C4 to C5, wherein the data for transmission as SDT comprises at least one of: user data, control information, and a signaling message.

Example Embodiment C7. The method of any one of Example Embodiments C1 to C6, wherein determining that the at least one proximity condition is fulfilled comprises determining that the at least one resource for the SDT at least partially overlaps in time with the at least one paging resource.

Example Embodiment C8. The method of any one of Example Embodiments C1 to C7, wherein determining that the at least one proximity condition is fulfilled comprises determining that an amount of time (i.e., time gap, Tg) between the at least one resource for the SDT and the at least one paging resource is less than a threshold.

Example Embodiment C9. The method of any one of Example Embodiments C1 to C8, wherein determining that the at least one proximity condition is fulfilled comprises: determining that at least one condition related to a periodicity (Tsr) of the at least one resource for the SDT is met.

Example Embodiment C10. The method of any one of Example Embodiments C1 to C9, wherein determining that the at least one proximity condition is fulfilled comprises: determining that at least one condition related to a periodicity (Tpr) of the at least one paging resource is met.

Example Embodiment C11. The method of any one of Example Embodiments C1 to C10, wherein determining that the at least one proximity condition is fulfilled comprises: determining a relationship between a periodicity of the at least one resource for the SDT (Tsr) and a periodicity of the at least one paging resource (Tpr); and determining that the relationship fulfills at least one condition.

Example Embodiment C12. The method of any one of Example Embodiments C1 to C11, wherein performing the at least one task based on the at least one proximity condition being fulfilled comprises: postponing the SDT: discarding the SDT; or switching from a first SDT method to a second SDT method.

Example Embodiment C13. The method of Example Embodiment C12, wherein switching from the first SDT method to the second SDT method comprises: switching from a CG-SDT method to a RACH-SDT method: switching from a RACH-SDT method to a CG-SDT method: switching from a 4-step RACH-SDT method to a 2-step RACH-SDT method; or switching from a 2-step RACH-SDT method to a 4-step RACH-SDT method.

Example Embodiment C14. The method of any one of Example Embodiments C1 to C13, wherein performing the at least one task based on the at least one proximity condition being fulfilled comprises postponing or discarding reception of the at least one paging related signal.

Example Embodiment C14A. The method of any one of Example Embodiments C1 to C13, wherein performing the at least one task based on the at least one proximity condition being fulfilled comprises receiving at least one paging related signal.

Example Embodiment C15. The method of Example Embodiments C1 to C14, further comprising: providing user data; and forwarding the user data to a host via the transmission to the network node.

Example Embodiment C16. A user equipment comprising processing circuitry configured to perform any of the methods of Example Embodiments C1 to C15.

Example Embodiment C17. A wireless device comprising processing circuitry configured to perform any of the methods of Example Embodiments C1 to C15.

Example Embodiment C18. A computer program comprising instructions which when executed on a computer perform any of the methods of Example Embodiments C1 to C15.

Example Embodiment C19. A computer program product comprising computer program, the computer program comprising instructions which when executed on a computer perform any of the methods of Example Embodiments C1 to C15.

Example Embodiment C20. A non-transitory computer readable medium storing instructions which when executed by a computer perform any of the methods of Example Embodiments C1 to C15.

### Group D Example Embodiments

Example Embodiment D1. A user equipment for adapting a small data transmission (SDT) and/or paging reception, comprising: processing circuitry configured to perform any of the steps of any of the Group A and C Example Embodiments; and power supply circuitry configured to supply power to the processing circuitry.

Example Embodiment D2. A network node for adapting a small data transmission (SDT) and/or paging reception, the network node comprising: processing circuitry configured to perform any of the steps of any of the Group B Example Embodiments: power supply circuitry configured to supply power to the processing circuitry.

Example Embodiment D3. A user equipment (UE) for adapting a small data transmission (SDT) and/or paging reception, the UE comprising: an antenna configured to send and receive wireless signals: radio front-end circuitry connected to the antenna and to processing circuitry, and configured to condition signals communicated between the antenna and the processing circuitry: the processing circuitry being configured to perform any of the steps of any of the Group A and C Example Embodiments: an input interface connected to the processing circuitry and configured to allow input of information into the UE to be processed by the processing circuitry: an output interface connected to the processing circuitry and configured to output information from the UE that has been processed by the processing circuitry; and a battery connected to the processing circuitry and configured to supply power to the UE.

Example Embodiment D4. A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A and C Example Embodiments to receive the user data from the host.

Example Embodiment D5. The host of the previous Example Embodiment, wherein the cellular network further includes a network node configured to communicate with the UE to transmit the user data to the UE from the host.

Example Embodiment D6. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment D7. A method implemented by a host operating in a communication system that further includes a network node and a user equipment (UE), the method comprising: providing user data for the UE; and initiating a transmission carrying the user data to the UE via a cellular network comprising the network node, wherein the UE performs any of the operations of any of the Group A embodiments to receive the user data from the host.

Example Emboidment D8. The method of the previous Example Embodiment, further comprising: at the host, executing a host application associated with a client application executing on the UE to receive the user data from the UE.

Example Embodiment D9. The method of the previous Example Embodiment, further comprising: at the host, transmitting input data to the client application executing on the UE, the input data being provided by executing the host application, wherein the user data is provided by the client application in response to the input data from the host application.

Example Emboidment D10. A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A and C Example Embodiments to transmit the user data to the host.

Example Emboidment D11. The host of the previous Example Embodiment, wherein the cellular network further includes a network node configured to communicate with the UE to transmit the user data from the UE to the host.

Example Embodiment D12. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment D13. A method implemented by a host configured to operate in a communication system that further includes a network node and a user equipment (UE), the method comprising: at the host, receiving user data transmitted to the host via the network node by the UE, wherein the UE performs any of the steps of any of the Group A and C Example Embodiments to transmit the user data to the host.

Example Embodiment D14. The method of the previous Example Embodiment, further comprising: at the host, executing a host application associated with a client application executing on the UE to receive the user data from the UE.

Example Embodiment D15. The method of the previous Example Embodiment, further comprising: at the host, transmitting input data to the client application executing on the UE, the input data being provided by executing the host application, wherein the user data is provided by the client application in response to the input data from the host application.

Example Embodiment D16. A host configured to operate in a communication system to provide an over-the-top (OTT) service, the host comprising: processing circuitry configured to provide user data; and a network interface configured to initiate transmission of the user data to a network node in a cellular network for transmission to a user equipment (UE), the network node having a communication interface and processing circuitry, the processing circuitry of the network node configured to perform any of the operations of any of the Group B Example Embodiments to transmit the user data from the host to the UE.

Example Embodiment D17. The host of the previous Example Embodiment, wherein: the processing circuitry of the host is configured to execute a host application that provides the user data; and the UE comprises processing circuitry configured to execute a client application associated with the host application to receive the transmission of user data from the host.

Example Embodiment D18. A method implemented in a host configured to operate in a communication system that further includes a network node and a user equipment (UE), the method comprising: providing user data for the UE; and initiating a transmission carrying the user data to the UE via a cellular network comprising the network node, wherein the network node performs any of the operations of any of the Group B Example Embodiments to transmit the user data from the host to the UE.

Example Embodiment D19. The method of the previous Example Embodiment, further comprising, at the network node, transmitting the user data provided by the host for the UE.

Example Emboidment D20. The method of any of the previous 2 Example Embodiments, wherein the user data is provided at the host by executing a host application that interacts with a client application executing on the UE, the client application being associated with the host application.

Example Embodiment D21. A communication system configured to provide an over-the-top service, the communication system comprising: a host comprising: processing circuitry configured to provide user data for a user equipment (UE), the user data being associated with the over-the-top service; and a network interface configured to initiate transmission of the user data toward a cellular network node for transmission to the UE, the network node having a communication interface and processing circuitry, the processing circuitry of the network node configured to perform any of the operations of any of the Group B Example Embodiments to transmit the user data from the host to the UE.

Example Embodiment D22. The communication system of the previous Example Embodiment, further comprising: the network node; and/or the user equipment.

Example Embodiment D23. A host configured to operate in a communication system to provide an over-the-top (OTT) service, the host comprising: processing circuitry configured to initiate receipt of user data; and a network interface configured to receive the user data from a network node in a cellular network, the network node having a communication interface and processing circuitry, the processing circuitry of the network node configured to perform any of the operations of any of the Group B Example Embodiments to receive the user data from a user equipment (UE) for the host.

Example Embodiment D24. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment D25. The host of the any of the previous 2 Example Embodiments, wherein the initiating receipt of the user data comprises requesting the user data. Example Embodiment D26. A method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps of any of the Group B Example Embodiments to receive the user data from the UE for the host.

Example Embodiment D27. The method of the previous Example Embodiment, further comprising at the network node, transmitting the received user data to the host.

1. A method (1000) by a user equipment, UE, (412A-D) for adapting a small data transmission, SDT, the method comprising:
determining (1002) that at least one proximity condition is fulfilled, the at least one proximity condition being associated with:
at least one resource for a SDT, and
at least one paging resource for receiving at least one paging related signal from a network node; and
performing (1004) at least one task for adapting the SDT based on the at least one proximity condition being fulfilled.

2. The method of claim 1, wherein determining that the at least one proximity condition is fulfilled comprises determining that the at least one resource for the SDT at least partially overlaps in time with the at least one paging resource.

3. The method of any one of claims 1 to 2, wherein performing the at least one task for adapting the SDT based on the at least one proximity condition being fulfilled comprises at least one of:
monitoring at least one paging occasion associated with the at least one paging resource, and
receiving at least one paging related signal.

4. The method of any one of claims 1 to 3, wherein performing the at least one task for adapting the SDT based on the at least one proximity condition being fulfilled comprises:
dropping the SDT.

5. The method of any one of claims 1 to 3, wherein performing the at least one task for adapting the SDT based on the at least one proximity condition being fulfilled comprises at least one of:
postponing the SDT; and
switching from a first SDT method to a second SDT method.

6. The method of claim 5, wherein switching from the first SDT method to the second SDT method comprises:
switching from a Configured Grant-SDT, CG-SDT, method to a Random Access Channel-SDT, RACH-SDT, method:
switching from a RACH-SDT method to a CG-SDT method:
switching from a 4-step RACH-SDT method to a 2-step RACH-SDT method; or switching from a 2-step RACH-SDT method to a 4-step RACH-SDT method.

7. The method of any one of claims 1 to 6, further comprising receiving, from a network node (410A-B), information associated with the at least one resource for a SDT.

8. The method of claim 7, wherein the information associated with the at least one resource for the SDT comprises at least one of:
a Physical Uplink Shared Channel, PUSCH, allocation;
a Random Access Channel, RACH, allocation:
a frequency of a pre-configured radio resource:
information indicating that the at least one resource for the SDT is periodic and/or a periodicity of the at least one resource for the SDT:
information indicating that the at least one resource for the SDT is aperiodic; and
a Timing Advance, TA, value associated with a pre-configured radio resource.

9. The method of any one of claims 1 to 8, wherein the at least one resource for the SDT is associated with a configured grant, CG.

10. The method of any one of claims 1 to 9, further comprising receiving, from a network node, information associated with the at least one paging reception resource.

11. The method of claim 10, wherein the information associated with the at least one paging reception resource comprises a paging configuration and/or a paging reception periodicity.

12. The method of any one of claims 1 to 11, further comprising determining that the UE has data to transmit using the at least one resource for the SDT.

13. The method of claim 12, wherein determining that the UE has the data to transmit comprises at least one of:
receiving data for transmission as SDT:
determining that a buffer contains data:
determining a need to retransmit previously transmitted data:
receiving a request from a network node; and
determining that a timer has expired.

14. The method of any one of claims 12 to 13, wherein the data for the SDT comprises at least one of: user data, control information, and a signaling message.

15. The method of any one of claims 1 to 14, wherein determining that the at least one proximity condition is fulfilled comprises:
determining that an amount of time between the at least one resource for the SDT and the at least one paging resource is less than a threshold.

16. The method of any one of claims 1 to 15, wherein determining that the at least one proximity condition is fulfilled comprises:
determining that at least one condition related to a periodicity, Tsr, of the at least one resource for the SDT is met.

17. The method of any one of claims 1 to 16, wherein determining that the at least one proximity condition is fulfilled comprises:
determining that at least one condition related to a periodicity, Tpr, of the at least one paging resource is met.

18. The method of any one of claims 1 to 17, wherein determining that the at least one proximity condition is fulfilled comprises:
determining a relationship between a periodicity of the at least one resource for the SDT, Tsr, and a periodicity of the at least one paging resource, Tpr; and
determining that the relationship fulfills at least one condition.

19. A user equipment, UE, (412A-D) for adapting a small data transmission, SDT, the UE comprising processing circuitry (502) configured to:
determine that at least one proximity condition is fulfilled, the at least one proximity condition being associated with:
at least one resource for a SDT, and
at least one paging resource for receiving at least one paging related signal from a network node; and
perform at least one task for adapting the SDT based on the at least one proximity condition being fulfilled.

20. The UE of claim 19, wherein when determining that the at least one proximity condition is fulfilled, the processing circuitry is configured to determine that the at least one resource for the SDT at least partially overlaps in time with the at least one paging resource.

21. The UE of any one of claims 19 to 20, wherein when performing the at least one task for adapting the SDT, the processing circuitry is configured to perform at least one of:
monitoring at least one paging occasion associated with the at least one paging resource, and
receiving at least one paging related signal.

22. The UE of any one of claims 19 to 21, wherein when performing the at least one task for adapting the SDT, the processing circuitry is configured to:
drop the SDT.

23. The UE of any one of claims 19 to 22, wherein when performing the at least one task for adapting the SDT, the processing circuitry is configured to perform at least one of:
postpone the SDT; and
switch from a first SDT method to a second SDT method.

24. The UE of claim 23, wherein when switching from the first SDT method to the second SDT, the processing circuitry is configured to:
switch from a Configured Grant-SDT, CG-SDT, method to a Random Access Channel-SDT, RACH-SDT, method:
switch from a RACH-SDT method to a CG-SDT method:
switch from a 4-step RACH-SDT method to a 2-step RACH-SDT method; or switch from a 2-step RACH-SDT method to a 4-step RACH-SDT method.

25. The UE of any one of claims 19 to 24, wherein the processing circuitry is configured to receive, from a network node (410A-B), information associated with the at least one resource for a SDT.

26. The UE of claim 25, wherein the information associated with the at least one resource for the SDT comprises at least one of:
a Physical Uplink Shared Channel, PUSCH, allocation;
a Random Access Channel, RACH, allocation;
a frequency of a pre-configured radio resource;
information indicating that the at least one resource for the SDT is periodic and/or a periodicity of the at least one resource for the SDT:
information indicating that the at least one resource for the SDT is aperiodic; and
a Timing Advance, TA, value associated with a pre-configured radio resource.

27. The UE of any one of claims 19 to 26, wherein the at least one resource for the SDT is associated with a configured grant, CG.

28. The UE of any one of claims 19 to 27, wherein the processing circuitry is configured to receive, from a network node, information associated with the at least one paging reception resource.

29. The UE of claim 28, wherein the information associated with the at least one paging reception resource comprises a paging configuration and/or a paging reception periodicity.

30. The UE of any one of claims 19 to 29, wherein the processing circuitry is configured to determine that the UE has data to transmit using the at least one resource for the SDT.

31. The UE of claim 30, wherein when determining that the UE has the data to transmit, the processing circuitry is configured to perform at least one of:
receiving data for transmission as SDT:
determining that a buffer contains data:
determining a need to retransmit previously transmitted data:
receiving a request from a network node; and
determining that a timer has expired.

32. The UE of any one of claims 30 to 31, wherein the data for the SDT comprises at least one of: user data, control information, and a signaling message.

33. The UE of any one of claims 19 to 32, wherein when determining that the at least one proximity condition is fulfilled, the processing circuitry is configured to:
determine that an amount of time between the at least one resource for the SDT and the at least one paging resource is less than a threshold.

34. The UE of any one of claims 19 to 33, wherein when determining that the at least one proximity condition is fulfilled, the processing circuitry is configured to:
determine that at least one condition related to a periodicity, Tsr, of the at least one resource for the SDT is met.

35. The UE of any one of claims 19 to 34, wherein when determining that the at least one proximity condition is fulfilled, the processing circuitry is configured to:
determine that at least one condition related to a periodicity, Tpr, of the at least one paging resource is met.

36. The UE of any one of claims 19 to 35, wherein when determining that the at least one proximity condition is fulfilled, the processing circuitry is configured to:
determine a relationship between a periodicity of the at least one resource for the SDT, Tsr, and a periodicity of the at least one paging resource, Tpr; and
determine that the relationship fulfills at least one condition.
